(19) United States
(12) Patent Application Publication
(10) Pub. No.: US 2023/0345543 A1
(43) Pub. Date: Oct. 26, 2023

(54) RELEASE-18 (REL-18) SUPPORT OF TWO TIMING ADVANCES (TAS) FOR SINGLE CELL

(71) Applicant: Intel Corporation, Santa Clara, CA (US)

(72) Inventors: Xun Tang, Beijing (CN); Bishwarup Mondal, San Ramon, CA (US); Candy Yiu, Portland, OR (US); Seau Sian Lim, Swindon (GB); Yi Guo, Shanghai (CN)

(21) Appl. No.: 18/307,484

(22) Filed: Apr. 26, 2023

Related U.S. Application Data
(60) Provisional application No. 63/336,044, filed on Apr. 28, 2022.

(51) Int. Cl. H04W 74/08; H04W 72/231

(52) U.S. Cl. CPC H04W 74/0833; H04W 72/231

(57) ABSTRACT

Systems, apparatuses, methods, and computer-readable media are provided for a user equipment (UE) in a new radio (NR) system to support two timing advances (TAs) in a single cell of a cellular network. In some embodiments, one or more of the TAs may be indicated to the UE by a base station (e.g., in a MAC RAR or a MAC CE). Other embodiments may be described and/or claimed.

### CROSS REFERENCE TO RELATED APPLICATION

The present application claims priority to U.S. Provisional Patent Application No. 63/336,044, which was filed Apr. 28, 2022; the disclosures of which are hereby incorporated by reference.

### FIELD

Various embodiments generally may relate to the field of wireless communications. For example, some embodiments may relate to . . . .

### BACKGROUND

Various embodiments generally may relate to the field of wireless communications.

### BRIEF DESCRIPTION OF THE FIGURES

FIG. 1 relates to an example 1-timing advance (TA) concept, in accordance with various embodiments.

FIG. 2 relates to an example multiple transmit/receive point (mTRP) concept, in accordance with various embodiments.

FIG. 3 relates to an example random access channel (RACH) procedure, in accordance with various embodiments.

FIG. 4 depicts an example Figure from a 3GPP TS, in accordance with various embodiments.

FIG. 5 depicts an example Figure from a 3GPP TS, in accordance with various embodiments.

FIG. 6 depicts an example Figure from a 3GPP TS, in accordance with various embodiments.

FIG. 7 depicts an example Figure from a 3GPP TS, in accordance with various embodiments.

FIG. 8 depicts an example medium access control (MAC) random access resource (RAR), in accordance with various embodiments.

FIG. 9 depicts a portion of an alternative example MAC RAR, in accordance with various embodiments.

FIG. 10 depicts an alternative example MAC RAR, in accordance with various embodiments.

FIG. 11 depicts an example Figure from a 3GPP TS, in accordance with various embodiments.

FIG. 12 depicts an example MAC CE, in accordance with various embodiments.

FIG. 13 illustrates a network in accordance with various embodiments.

FIG. 14 schematically illustrates a wireless network in accordance with various embodiments.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein.

FIG. 16 illustrates a network in accordance with various embodiments.

FIG. 17 depicts an example procedure for practicing the various embodiments discussed herein.

FIG. 18 depicts another example procedure for practicing the various embodiments.

FIG. 19 depicts another example procedure for practicing the various embodiments.

FIG. 20 depicts another example procedure for practicing the various embodiments.

FIG. 21 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

This Disclosure is Related to RAN1/RAN2

New Rel-18 WID for further enhancements on MIMO has been approved in RP-213598, where one of the objectives is to enable two TAs for single cell through one or more of the following:
Two TAs for UL multi-DCI for multi-TRP operation
Power control for UL single DCI for multi-TRP operation where unified TCI framework extension in objective 2 is assumed.

Embodiments herein relate to one or more of the following aspects to support two TAs:
1. Three options to enable two TAs for a single cell:
   Option 1: both TAs are used/valid for a single cell;
   Option 2: selective activation of TA for a single cell
   Option 3: hybrid mode, i.e., some cells may use first TA, some cells may use second TA, some cells may use both
2. For each option above, how to perform initial TA establishment and TA maintenance

When two TAs for a single cell are used simultaneously, a corresponding third generation partnership project (3GPP) specification change is needed to support the co-existence of them; when only one TA is valid at a time and two TAs are configured, the corresponding activation/deactivation mechanism is needed. Other TA enhancements, such as TA estimation without RACH procedure, TA timer handling without MAC reset, are also discussed in embodiments herein.

When two TAs are enabled for a single cell, it can be used in a deployment scenario where one cell has two or more TRPs, and no ideal backhaul or synchronization between them is required, so this feature can be used to enlarge the multiple TRP usage with less backhaul or synchronization restriction.

And this two-TA method can also be used in other scenarios when two TAs are needed in a single cell.

### Background Information

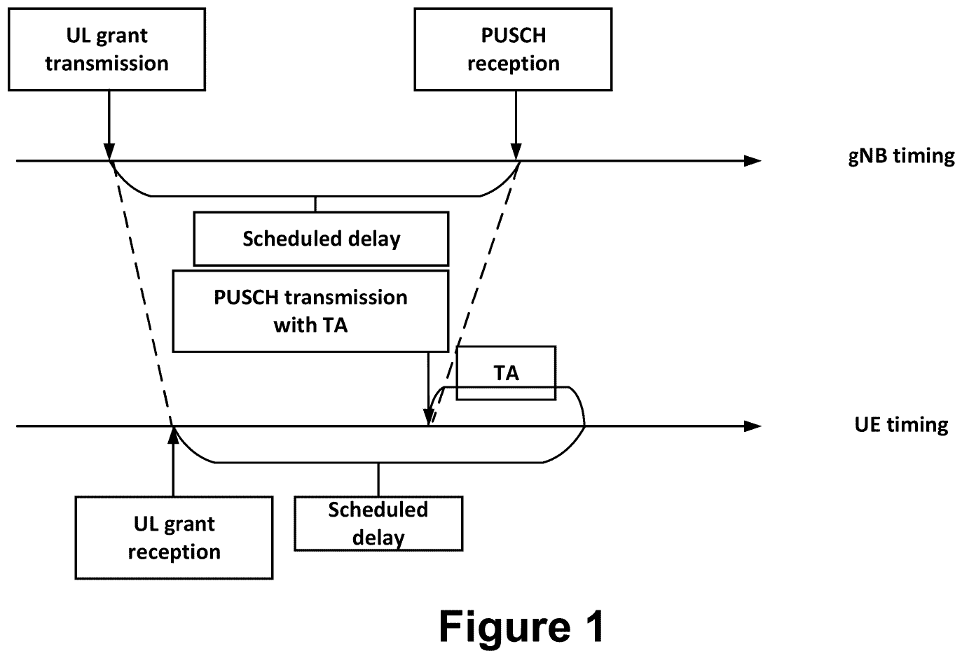

The term TA may relate to “Timing Advance.” TA is used to compensate the Round Trip Time (RTT) between UE and gNB for reception of uplink data and signaling. As illustrated by the following figure, according to the distance between UE and gNB, there is a delay between UL grant transmission at gNB side and UL grant reception at UE side. From gNB point of view, the scheduled delay between UL grant transmission and PUSCH reception is fixed, e.g., 6 ms. From UE point of view, to meet the requirement of fixed scheduled delay, after UL grant is received UE has to transmit PUSCH earlier, i.e., timing advance. And usually TA value is equal to the RTT between UE and gNB. See, e.g., FIG. 1.

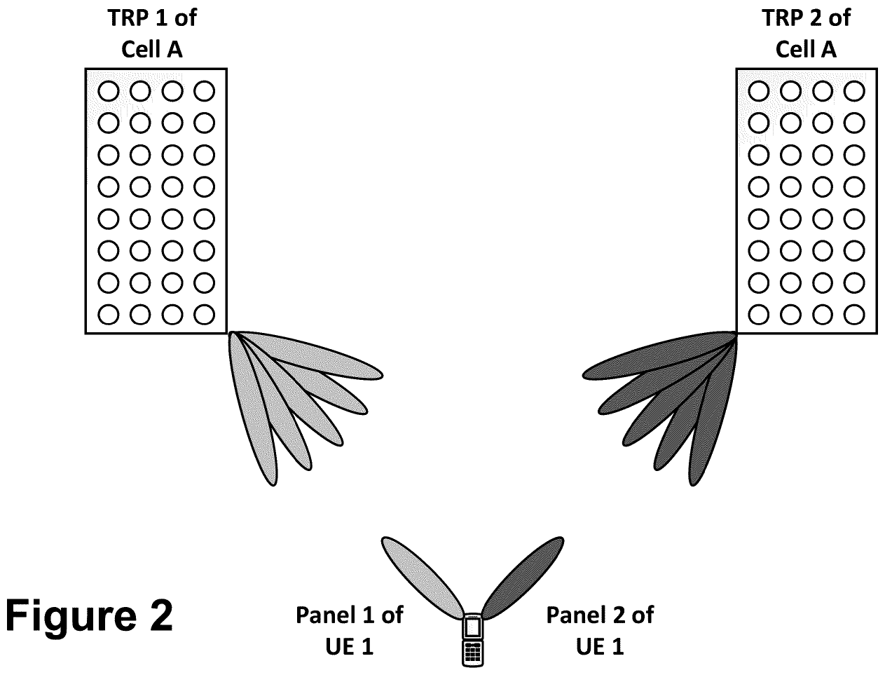

The term TRP may relate to a “Transmit/Receive Point.” It can also be considered as antenna array. The usage of multiple TRP (mTRP) is to enable more antennas for higher throughput and reliability. One cell can have up to two TRPs located in different places. It means it's possible that, the distance between UE and TRP1, and the distance between UE and TRP2, is different. When the TA difference is less than a threshold, e.g., the length of cyclic prefix (CP), it can be considered as multiple path components and no special handling is needed. But if the TA difference is large, then separate TA values are needed for different TRPs. This is the reason why we need to consider supporting two TAs. See, e.g., FIG. 2.

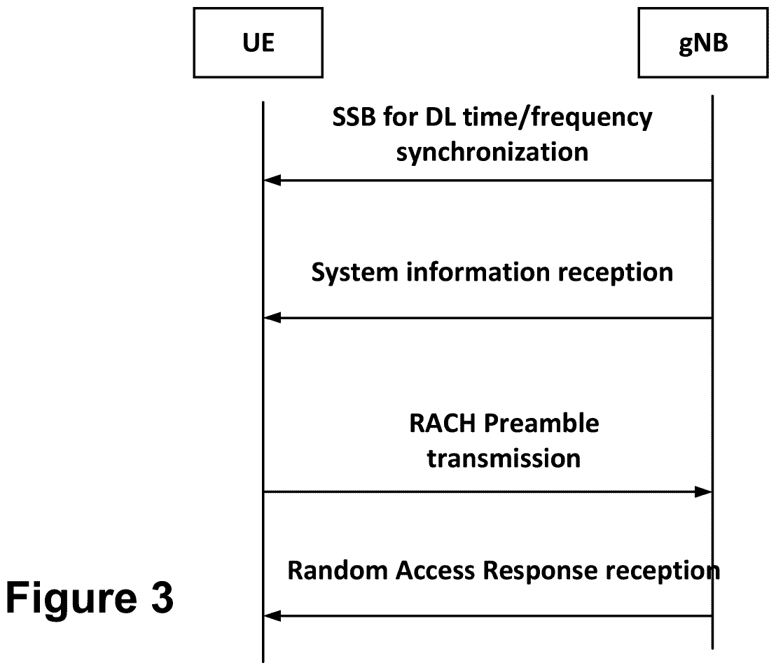

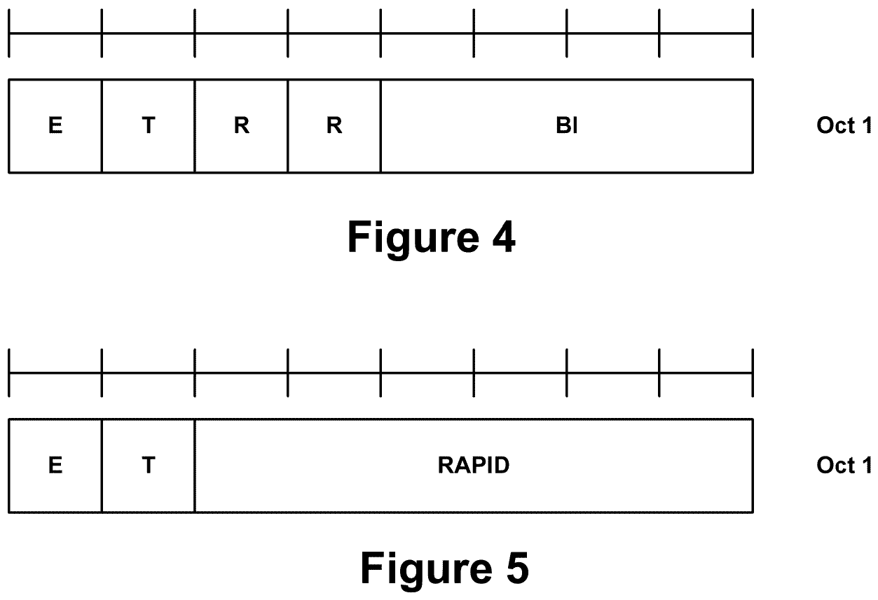

The term RA may relate to “Random Access.” RA procedure is used to get TA value. A typical RA procedure is shown in FIG. 3.

After UE finishes DL time and frequency synchronization and gets RACH configuration from system information, UE can send preamble to gNB. Based on the timing of preamble reception, gNB estimates the TA value and sends it back to UE within RAR message. The signaling structure of RAR is as below, and the field “Timing Advance Command” is the TA value.

6.1.5 MAC PDU (Random Access Response)

A MAC PDU may include one or more MAC subPDUs and optionally padding. Each MAC subPDU consists one of the following:
a MAC subheader with Backoff Indicator only;
a MAC subheader with RAPID only (i.e. acknowledgment for SI request);
a MAC subheader with RAPID and MAC RAR.

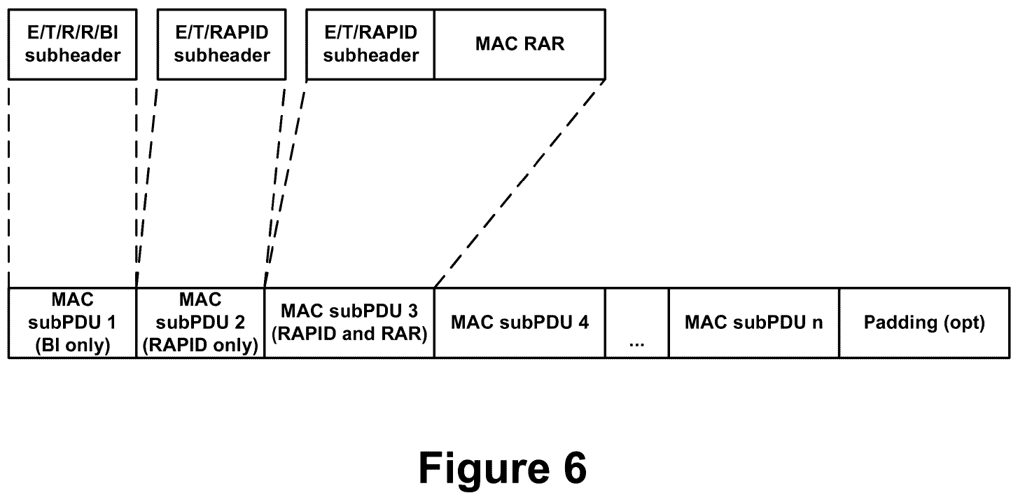

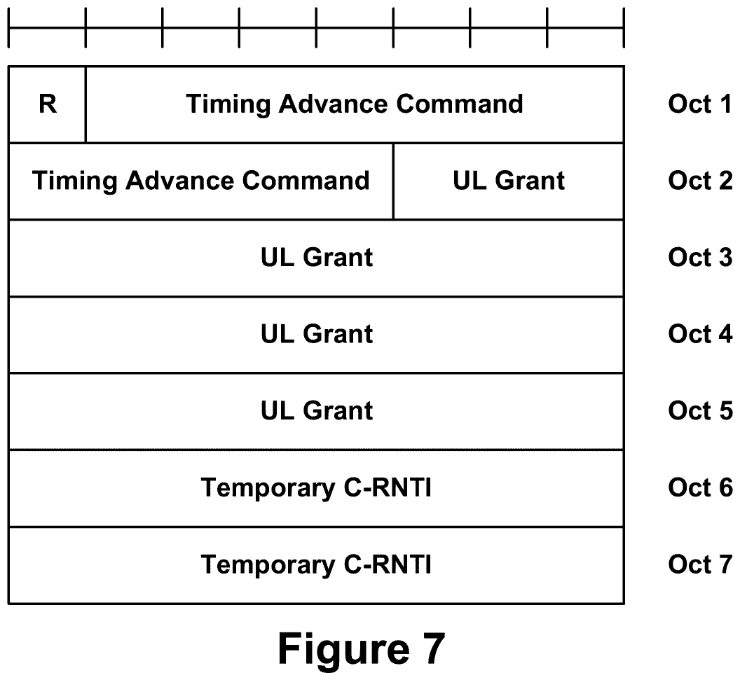

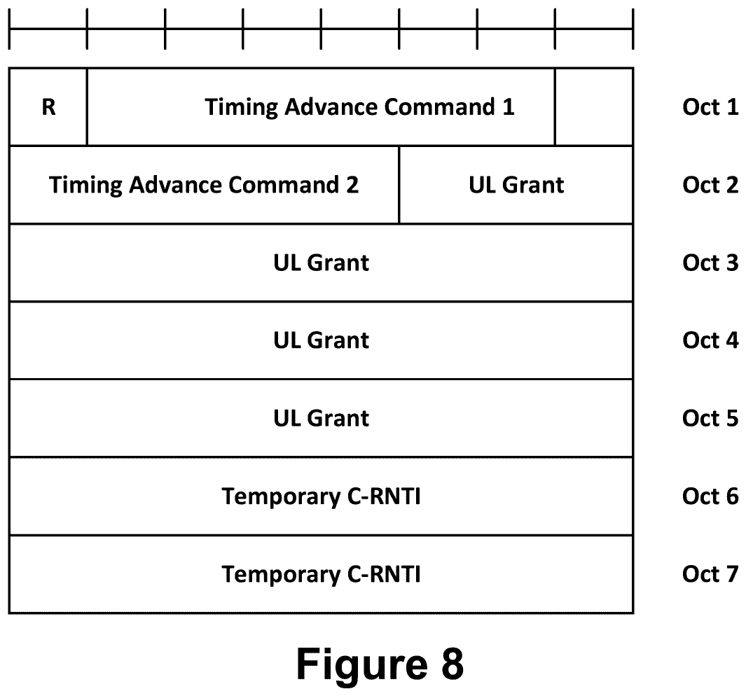

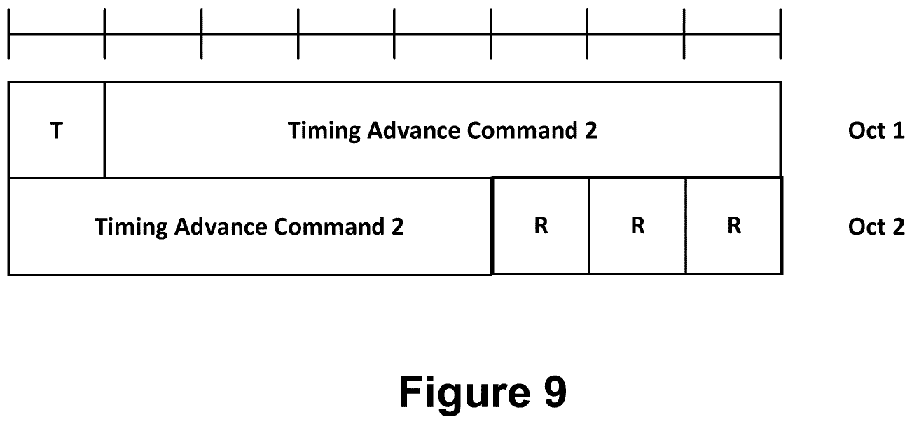

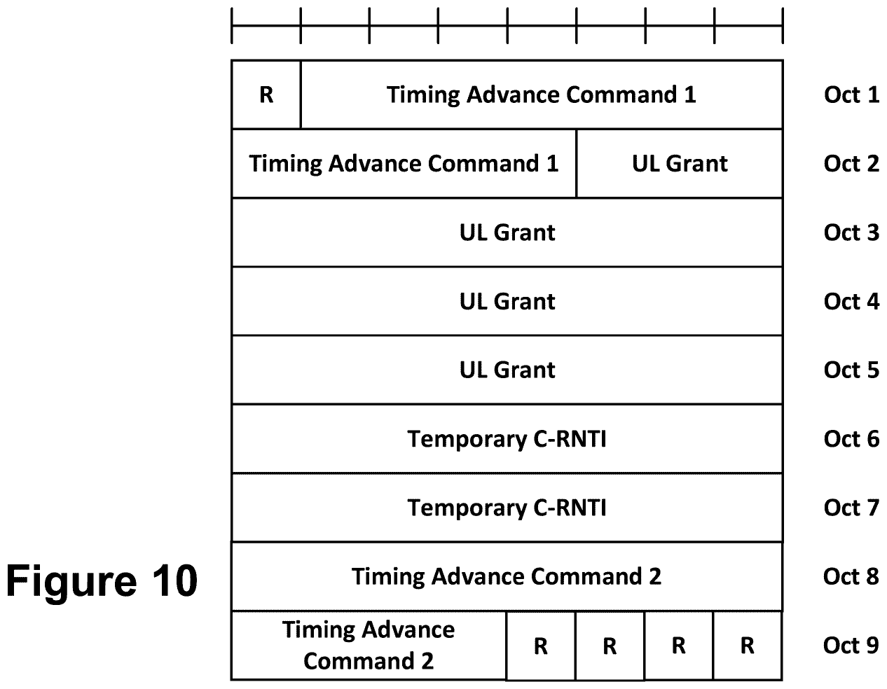

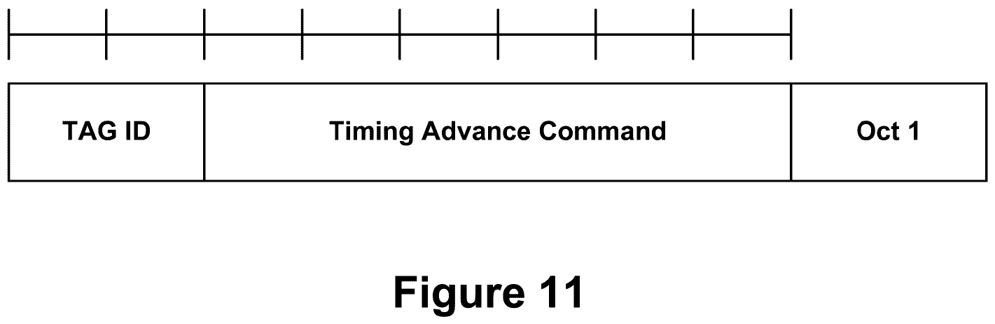

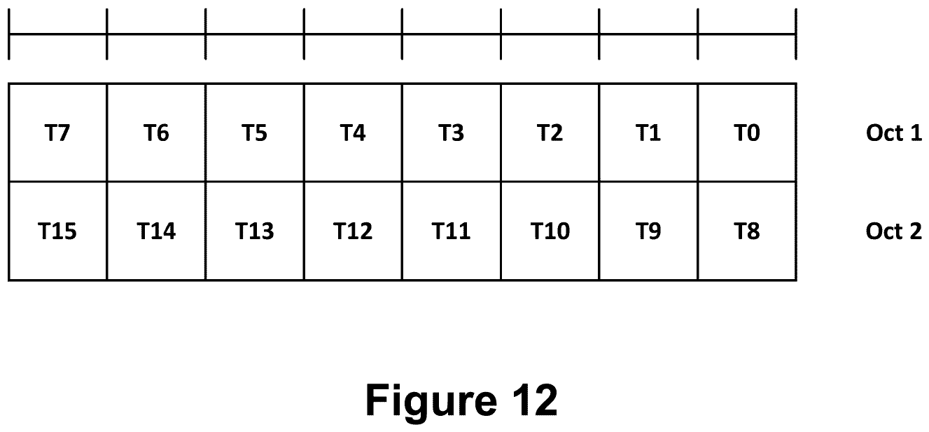

A MAC subheader with Backoff Indicator consists of five header fields E/T/R/R/BI as described in FIG. 6.1.5-1. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).

A MAC subheader with RAPID consists of three header fields E/T/RAPID as described in FIG. 6.1.5-2.

Padding is placed at the end of the MAC PDU if present. Presence and length of padding is implicit based on TB size, size of MAC subPDU(s).

6.2.3 MAC Payload for Random Access Response

The MAC RAR is of fixed size as depicted in FIG. 6.2.3-1, and consists of the following fields:
R: Reserved bit, set to “0”;
Timing Advance Command: The Timing Advance Command field indicates the index value TA used to control the amount of timing adjustment that the MAC entity has to apply in TS 38.213 [6]. The size of the Timing Advance Command field is 12 bits;
UL Grant: The Uplink Grant field indicates the resources to be used on the uplink in TS 38.213 [6]. The size of the UL Grant field is 27 bits;
Temporary C-RNTI: The Temporary C-RNTI field indicates the temporary identity that is used by the MAC entity during Random Access. The size of the Temporary C-RNTI field is 16 bits.

The MAC RAR is octet aligned.

### Embodiment 1: Both TAs are Used/Valid for a Single Cell

During the initial access phase, an idle UE uses RACH procedure to get UL synchronized. And for a connected UE, it's also possible to use RACH to re-get UL synchronized during handover procedure or for failure recovery. This is for initial establishment of TA.

Initial Establishment of TA, Approach 1: Two-TA Mode (Single RACH Preamble)

Network can configure separate RACH resources, e.g., separate time/frequency resource for preamble transmission, or separate preamble indexes, or separate QCL information for PRACH association and transmission for two-TA mode. Meanwhile there are still RACH resources for legacy operation, i.e., single TA for a cell. The QCL information for PRACH association and transmission can be associated with the serving cell PCI or non-serving cell PCI.

After UE selects the two-TA mode RACH resource and transmits preamble, the preamble can be received by gNB (e.g., two TRPs, this is applicable to FR1 scenario). Then gNB can estimate the two TA values (e.g., one for each TRP). gNB includes the two TA values in one MAC PDU (Random Access Response message).

Considering the backward compatibility, the size of MAC RAR cannot be changed if UE still monitor RA-RNTI. One option is to split current “Timing Advance Command” (12 bit) into two fields as below, i.e., “Timing Advance Command 1” (6 bit) and “Timing Advance Command 2” (6 bit).

And another option is to use a second RAR for second TA (e.g., in the same MAC PDU with first RAR, or as a separate MAC PDU within the same RAR receiving window), meanwhile “R” field is changed to “T” field and used to indicate whether this is for second TA, i.e., bit 0 means this is first TA and bit 1 means this is second TA. It's also possible to not use “T” field, and when the same MAC subheader shows again it means it's for the second TA. 2-step RACH can also be used for such TA establishment and similar format can also be used to provide 2 TAs.

It's also possible that UE monitor a specific two-TA-RNTI for blind detection of PDCCH, or use a separate Msg2 PDCCH search space, so that a new RAR (Msg2 for 4-step RACH) is possible.

Another approach is that network send first TA using legacy method and second TA via next RRC message or a MAC CE. Since the first TA will allow the UE to perform the first access and sync to the network. It may be slower to go this way but it may be one option.

For UE in idle mode, network can provide configuration of separate RACH resources for two-TA mode in system information; and for UE in connected mode, the two-TA mode configuration can be sent to UE in Handover command when target cell supports 2 TA mode.

Further detail:
UE needs to indicate the capability that UE supports 2TA mode.
source gNB needs to indicate to target gNB during HO preparation phase that UE support 2 TA mode
target gNB needs to include separate preamble resources when 2 TA mode is enabled.

Initial Establishment of TA, Approach 2: Step by Step Mode (Two RACH Preambles)

The first TA is derived by legacy RACH procedure. For connected UE, network can configure/enable the second TA, e.g., along the configuration of second TRP. After this configuration, UE can initiate a RACH procedure to get the second TA. It could also be a contention-free RACH (e.g. via PDCCH order), which means network provides a dedicated RACH source and/or QCL information for PRACH association and transmission to UE as part of second TA configuration; and it could also be contention based RACH, and the preamble resource and/or QCL information for PRACH association and transmission is provided in system information or dedicated configuration in RRC message or a combination of dedicated RRC configuration and DCI indication (for PDCCH ordered PRACH) specifically for second TA. In both cases there is no need to change RAR structure. The QCL information for PRACH association and transmission can be associated with the serving cell PCI or non-serving cell PCI. Initial establishment of TA, Approach 3: UE estimates second TA without RACH

The first TA is derived by legacy RACH procedure. For connected UE, network can configure/enable two downlink reference signals for UE to measure, e.g., SSB or CSI-RS. By tracking the two downlink RSs (e.g., one for each TRP), UE can calculate the downlink timing difference of them, i.e., ΔT. Optionally a maximum difference between first TA and second TA can be configured by network, and if the difference between first TA and second TA exceeds this maximum value, the second TA is considered as not valid. So UE still needs to perform RACH to get TA.

The second TA value=the first TA value+2*ΔT.

TA Maintenance, Approach 1: By TA Command MAC CE

After Initial establishment of TA, the next step is TA maintenance. For the maintenance of UL time alignment, the TA timer “timeAlignmentTimer” is used to control how long the MAC entity considers the Serving Cell to be uplink time aligned, or the how long the TA value is valid.

If the second TA value is derived according to RACH procedure, along with the UE's movement, network needs to adjust UE's TA dynamically using TA command MAC CE as below.

And the description of TAG is as below:

Timing Advance Group: A group of Serving Cells that is configured by RRC and that, for the cells with a UL configured, using the same timing reference cell and the same Timing Advance value.

So when two TAs in a single cell is supported, one way is that one cell can belong to two TAGs. With each TAG, there is a TA value and a TA timer shared by all cells in this group. In this case a second TAG ID needs to be configured to this cell, and the structure of TA command MAC CE doesn't need to be changed. Another way is that this cell stills belong to one TAG, but there are two TA values in this TAG and each is with a dedicated TA timer. In this case, the TA command MAC CE needs to be updated, i.e., a TA ID should be present to indicate this TA command is for the first TA or second TA. It's also feasible that this TA ID could be indicated in MAC subheader, e.g., using a separate LCID/eLCID.

TA Maintenance, Approach 2: By Pre-Compensation

If the second TA value is estimated by UE itself. UE can continue updating TA without gNB's assistance. But it's still possible adjust TA by sending TA command MAC CE. And UE can report the TA value, if configured by network. Optionally, the TA timer can be disabled if UE can estimate TA by downlink measurements.

TA Failure Handling, Approach 1: Handling of TA Timer Expiry

When TA timer expires the legacy UE behavior is as follows:
1>when a timeAlignmentTimer expires:
   2>if the timeAlignmentTimer is associated with the PTAG:
      3>flush all HARQ buffers for all Serving Cells;
      3>notify RRC to release PUCCH for all Serving Cells, if configured;
      3>notify RRC to release SRS for all Serving Cells, if configured;
      3>clear any configured downlink assignments and configured uplink grants;
      3>clear any PUSCH resource for semi-persistent CSI reporting;
      3>consider all running timeAlignmentTimers as expired;
      3>maintain N_{TA} (defined in TS 38.211 [8]) of all TAGs.
   2>else if the timeAlignmentTimer is associated with an STAG, then for all Serving Cells belonging to this TAG:
   3>flush all HARQ buffers;
   3>notify RRC to release PUCCH, if configured;
   3>notify RRC to release SRS, if configured;
   3>clear any configured downlink assignments and configured uplink grants;
   3>clear any PUSCH resource for semi-persistent CSI reporting;
   3>maintain N_{TA} (defined in TS 38.211 [8]) of this TAG.

But in case of two TAs of a single cell and PTAG or STAG includes two TAs, only when two TA timers of two TAs both expires for the same TAG, UE needs to execute the operations above.

When only one TA timer expires, UE can still keep uplink time aligned, i.e., by using the other TA. Then the UE may:
Option 1: UE initiates RACH to re-sync up, e.g., using specific RACH resource for TA recovery;
Option 2: UE reports this TA timer failure to network, e.g., by MAC CE or RRC message.

And another alternative is that have primary TA under PTAG and STAG. That could be, if there are two TAs in the PTAG, then one of them is primary TA for primary TRP. The handling of the TAT failure of primary TA in PTAG is same as TA failure in PTAG, and the failure of secondary TA in PTAG is handled as TA failure in STAG.

TA Failure Handling, Approach 2: Handling of the Maximum Uplink Transmission Timing Difference Between TAGs

According to legacy UE behavior, “When the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity considers the timeAlignmentTimer associated with the SCell as expired.”

Similar to scells, we could also introduce TRP level TA failure. When there are two TAs of a single cell, the difference between these two TAs may also exceed the maximum uplink transmission timing difference (specified or configured by network). In this case, UE may also consider one TA timer expires, e.g., by default the TA timer related to the second TA expires or which TA timer is expired can be configured by network.

If the second TA is estimated by UE, UE may initiate RACH procedure to get TA value instead. It's also possible that UE monitor the second reference signal to continue update the ΔT and recalculate the second TA.

### Embodiment 2: Selective Activation of TA for a Single Cell

For a connected UE, the first TA has been enabled after initial access. And the second TA can be derived by another RACH procedure or UE estimation, i.e., second TA can be derived by any of the methods mentioned above. When there are two TAs for a single cell, how to select one for uplink transmission?

Approach 1: By DCI

Considering the scenario of UL multi-DCI for multi-TRP operation, TA indication can be included in DCI or derived from DCI.

In the first option, i.e., “TA indication is included in DCI”, a new field (e.g., TA ID) can be added in DCI to show which TA is used. It's possible to reuse TCI-state code point of DCI to show which TA is used, and in this way the association of TA ID and TCI-state should be provided first. E.g., the first TA can be considered as default TA which associates with a group of TCI-states; and there is another group of TCI-states which associates with the second TA. When one TCI-state is used for uplink transmission, the corresponding TA is used.

Approach 2: By MAC CE or RRC Message

A TA ID can be activated by MAC CE or RRC message, e.g., only first TA is activated, or only second TA is activated, or both TAs are activated. If both TAs are activated, UE can follow approach 1 to differentiate which TA is used for uplink transmission. If only one TA is activated, every uplink transmission (except for RACH) should use this TA.

Approach 3: Autonomous Switch

If only one TA is activated, and when the TA timer associated to this TA expires, UE can activate the second TA. E.g., for an uplink configured grant, UE can send uplink data every time the grant is valid. And when current TA timer expires, UE can switch to the other TA for uplink transmission. It's possible that this switch is triggered based on downlink measurements, e.g., when the quality of downlink reference signal corresponding to first TA is lower than a threshold, UE can switch to a second TA (possibly with activation of another TCI-state).

Whether UE can perform this autonomous TA switch can be controlled/enabled by network.

Relation Between TA ID and TAG ID

If one TAG only corresponds to one TA, the TAG can be activated or deactivated. If one TAG includes two TAs, then TA ID can be activated or deactivated.

### Embodiment 3: Hybrid Mode, i.e., Combination of Embodiment 1 and Embodiment 2

For MCG or SCG, there could be multiple TAGs configured. It's possible to have some cells with two TAs enabled, and have some cells with only one TA activated.

### Embodiment 4: Two TA Activation/De-Activation

Currently a serving cell is associated with one uplink timing and multiple serving cells within the same TAG is associated with the same uplink timing. Embodiments may associate a serving cell with 2 uplink timings (2 TA fields) and in addition to this, a serving cell may transition from single TRP operation to multi-DCI multi-TRP operation and vice-versa so it is also possible to be able to activate/de-active a TA field on a per serving cell basis (for e.g. first TA field can be active, or a second TA field can be active or both a first and a second TA field can be active).

### Embodiment 5: Other Complementary Designs

Regarding the criterion the UE use to decide whether two TA mode or single TA mode should be used, several options can be considered as below:
Option 1: A two TA mode capable UE always uses two TA mode if the network allows this.
Option 2: Only enabled by network. E.g., after UE gets access to the network, then two-TA mode is enabled by network.
Option 3: Based on IDLE mode measurement. E.g., when the delay spread of radio channel is larger than a threshold, UE decides to enable the second TA or use two-TA preamble for RACH.

How can the UE know the association between TA value and corresponding TRPs?

There are two options:
Option 1: the network has to configure the association between TA ID/TAG and TRPs before the UE triggers RACH; And then in MAC CE, the network only needs to indicate the TA ID; This preconfiguration can be done via broadcast signalling or dedicated signalling.
Option 2: In RAR, the network indicates TA and corresponding TRP.

An example RRC configuration for the mapping between TAG and TA ID is as follows:
Option 1: one TAG includes two TAs.

TAG-Config

The IE TAG-Config is used to configure parameters for a time-alignment group.

TAG-Config information element

```
-- ASNISTART
-- TAG-TAG-CONFIG-START
TAG-Config ::=  SEQUENCE {
  tag-ToReleaseList  SEQUENCE (SIZE (1..maxNrofTAGs)) OF TAG-Id
      OPTIONAL, -- Need N
  tag-ToAddModList  SEQUENCE (SIZE (1..maxNrofTAGs)) OF TAG
      OPTIONAL -- Need N
}
TAG ::=  SEQUENCE {
  tag-Id  TAG-Id,
  timeAlignmentTimer  TimeAlignmentTimer,
    ...
    timeAlignmentTimer2  TimeAlignmentTimer,
    primaryTA  ENUMERATED { TA1, TA2 }
}
TAG-Id ::=  INTEGER (0..maxNrofTAGs-1)
TimeAlignmentTimer ::=  ENUMERATED {ms500, ms750, ms1280, ms1920, ms2560,
ms5120, ms10240, infinity}
-- TAG-TAG-CONFIG-STOP
-- ASN1STOP
```

TAG field descriptions
tag-Id
Indicates the TAG of the SpCell or an SCell,
see TS 38.321 [3]. Uniquely identifies the
TAG within the scope of a Cell Group (i.e. MCG or SCG).
timeAlignmentTimer
Value in ms of the time AlignmentTimer for TAG with
ID tag-Id, as specified in TS 38.321 [3].
timeAlignmentTimer2
Value in ms of the time AlignmentTimer for
the second TA of TAG with ID tag-Id, as
specified in TS 38.321 [3].
primaryTA
Indicates which TA is the primary TA, i.e., TA1 or TA2

Option 2: one cell belongs to two TAGs (each TAG still corresponds to one TA value and one TA timer)
ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

ServingCellConfig information element

```
-- ASN1START
-- TAG-SERVINGCELLCONFIG-START
ServingCellConfig ::=  SEQUENCE {
  <unnecessary parts omitted>
    tag-Id  TAG-Id,
  tag-Id2  TAG-Id,
    <unnecessary parts omitted>
}
```

tag-Id
Timing Advance Group ID, as specified in TS 38.321 [3],
which this cell belongs to.
tag-Id2
Timing Advance Group ID, as specified in TS 38.321 [3],
the second TAG which this cell belongs to.

Regarding the mapping between TRP and TA ID, some rules are as follows:

If there is no second TA configured/enabled, all TRP uses current single TA of this cell, i.e., all TRPs or TCI-states associate with the same TA;

If second TA is configured/enabled by network, the mapping rule between TA ID and TRP ID (or TCI-state ID) is also configured by network.

Option 1: Via RRC Signaling, e.g., Dedicated Signaling or Broadcast Signaling

| | |
|---|---|
| TA-MappingConfig ::= | SEQUENCE { |
| useTA1 | SEQUENCE (SIZE(1..maxNrofTCI-States)) OF TCI-StateId, |
| useTA2 | SEQUENCE (SIZE(1..maxNrofTCI-States)) OF TCI-StateId, |

<unnecessary parts omitted>
}
Or

| | |
|---|---|
| TA-MappingConfig ::= | SEQUENCE { |
| useTA1 | SEQUENCE (SIZE(1..maxNrofTRP)) OF TRP-Id, |
| useTA2 | SEQUENCE (SIZE(1..maxNrofTRP)) OF TRP-Id, |

<unnecessary parts omitted>
}
Or use bitmap to represent the group of TCI-states

| | |
|---|---|
| TA-MappingConfig ::= | SEQUENCE { |
| useTA1 | BIT STRING (SIZE (maxNrofTCI-States)), |
| useTA2 | BIT STRING (SIZE (maxNrofTCI-States)),, |

<unnecessary parts omitted>
}
or use bitmap to represent the group of TRP

| | |
|---|---|
| TA-MappingConfig ::= | SEQUENCE { |
| useTA1 | BIT STRING (SIZE(1..maxNrofTRP)), |
| useTA2 | BIT STRING (SIZE(1..maxNrofTRP)), |

<unnecessary parts omitted>
}

It's also possible that only “useTA2” field is present, and other TRPs and TCI-states associate with TA1 by default.

Option 2: Via MAC CE

A new LCID/eLCID is used to identify a MAC subheader for this mapping purpose. And a MAC CE payload includes the group of TRP ID or TCI-state ID for each TA. For example, the following MAC CE is used indicate which TRP ID associates TA2 (indicating bit 1). If the corresponding Tx is bit 0, it means TRP ID x associates TA1.

Option 3: Via DCI

In this case, TA ID and (TRP ID, or TCI-state ID, TCI-state index) can be included in DCI. So there is an explicit association between TA ID and (TRP or TCI-state) for each uplink transmission.

### Systems and Implementations

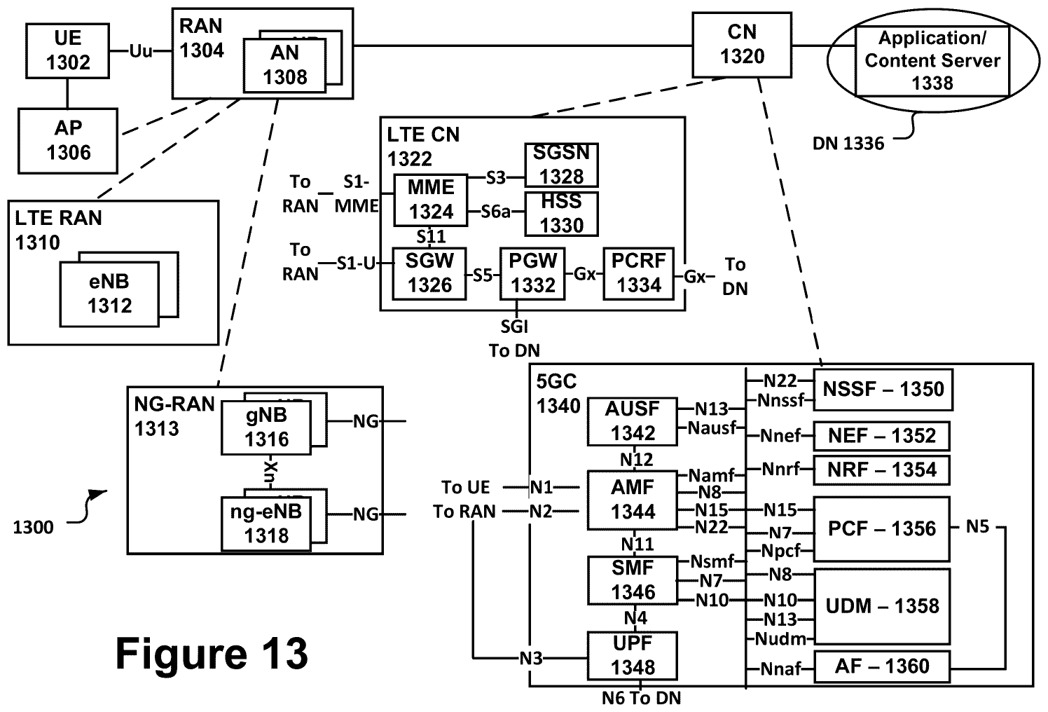

FIGS. 13-16 illustrate various systems, devices, and components that may implement aspects of disclosed embodiments.

FIG. 13 illustrates a network 1300 in accordance with various embodiments. The network 1300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1300 may include a UE 1302, which may include any mobile or non-mobile computing device designed to communicate with a RAN 1304 via an over-the-air connection. The UE 1302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1302 may additionally communicate with an AP 1306 via an over-the-air connection. The AP 1306 may manage a WLAN connection, which may serve to offload some/all network traffic from the RAN 1304. The connection between the UE 1302 and the AP 1306 may be consistent with any IEEE 802.11 protocol, wherein the AP 1306 could be a wireless fidelity (Wi-Fi®) router. In some embodiments, the UE 1302, RAN 1304, and AP 1306 may utilize cellular-WLAN aggregation (for example, LWA/LWIP). Cellular-WLAN aggregation may involve the UE 1302 being configured by the RAN 1304 to utilize both cellular radio resources and WLAN resources.

The RAN 1304 may include one or more access nodes, for example, AN 1308. AN 1308 may terminate air-interface protocols for the UE 1302 by providing access stratum protocols including RRC, PDCP, RLC, MAC, and L1 protocols. In this manner, the AN 1308 may enable data/voice connectivity between CN 1320 and the UE 1302. In some embodiments, the AN 1308 may be implemented in a discrete device or as one or more software entities running on server computers as part of, for example, a virtual network, which may be referred to as a CRAN or virtual baseband unit pool. The AN 1308 be referred to as a BS, gNB, RAN node, eNB, ng-eNB, NodeB, RSU, TRxP, TRP, etc. The AN 1308 may be a macrocell base station or a low power base station for providing femtocells, picocells or other like cells having smaller coverage areas, smaller user capacity, or higher bandwidth compared to macrocells.

In embodiments in which the RAN 1304 includes a plurality of ANs, they may be coupled with one another via an X2 interface (if the RAN 1304 is an LTE RAN) or an Xn interface (if the RAN 1304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1304 may each manage one or more cells, cell groups, component carriers, etc. to provide the UE 1302 with an air interface for network access. The UE 1302 may be simultaneously connected with a plurality of cells provided by the same or different ANs of the RAN 1304. For example, the UE 1302 and RAN 1304 may use carrier aggregation to allow the UE 1302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1302 or AN 1308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1304 may be an LTE RAN 1310 with eNBs, for example, eNB 1312. The LTE RAN 1310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1304 may be an NG-RAN 1314 with gNBs, for example, gNB 1316, or ng-eNBs, for example, ng-eNB 1318. The gNB 1316 may connect with 5G-enabled UEs using a 5G NR interface. The gNB 1316 may connect with a 5G core through an NG interface, which may include an N2 interface or an N3 interface. The ng-eNB 1318 may also connect with the 5G core through an NG interface, but may connect with a UE via an LTE air interface. The gNB 1316 and the ng-eNB 1318 may connect with each other over an Xn interface.

In some embodiments, the NG interface may be split into two parts, an NG user plane (NG-U) interface, which carries traffic data between the nodes of the NG-RAN 1314 and a UPF 1348 (e.g., N3 interface), and an NG control plane (NG-C) interface, which is a signaling interface between the nodes of the NG-RAN 1314 and an AMF 1344 (e.g., N2 interface).

The NG-RAN 1314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1302 can be configured with multiple BWPs where each BWP configuration has a different SCS. When a BWP change is indicated to the UE 1302, the SCS of the transmission is changed as well. Another use case example of BWP is related to power saving. In particular, multiple BWPs can be configured for the UE 1302 with different amount of frequency resources (for example, PRBs) to support data transmission under different traffic loading scenarios. A BWP containing a smaller number of PRBs can be used for data transmission with small traffic load while allowing power saving at the UE 1302 and in some cases at the gNB 1316. A BWP containing a larger number of PRBs can be used for scenarios with higher traffic load.

The RAN 1304 is communicatively coupled to CN 1320 that includes network elements to provide various functions to support data and telecommunications services to customers/subscribers (for example, users of UE 1302). The components of the CN 1320 may be implemented in one physical node or separate physical nodes. In some embodiments, NFV may be utilized to virtualize any or all of the functions provided by the network elements of the CN 1320 onto physical compute/storage resources in servers, switches, etc. A logical instantiation of the CN 1320 may be referred to as a network slice, and a logical instantiation of a portion of the CN 1320 may be referred to as a network sub-slice.

In some embodiments, the CN 1320 may be an LTE CN 1322, which may also be referred to as an EPC. The LTE CN 1322 may include MME 1324, SGW 1326, SGSN 1328, HSS 1330, PGW 1332, and PCRF 1334 coupled with one another over interfaces (or “reference points”) as shown. Functions of the elements of the LTE CN 1322 may be briefly introduced as follows.

The MME 1324 may implement mobility management functions to track a current location of the UE 1302 to facilitate paging, bearer activation/deactivation, handovers, gateway selection, authentication, etc.

The SGW 1326 may terminate an S1 interface toward the RAN and route data packets between the RAN and the LTE CN 1322. The SGW 1326 may be a local mobility anchor point for inter-RAN node handovers and also may provide an anchor for inter-3GPP mobility. Other responsibilities may include lawful intercept, charging, and some policy enforcement.

The SGSN 1328 may track a location of the UE 1302 and perform security functions and access control. In addition, the SGSN 1328 may perform inter-EPC node signaling for mobility between different RAT networks; PDN and S-GW selection as specified by MME 1324; MME selection for handovers; etc. The S3 reference point between the MME 1324 and the SGSN 1328 may enable user and bearer information exchange for inter-3GPP access network mobility in idle/active states.

The HSS 1330 may include a database for network users, including subscription-related information to support the network entities' handling of communication sessions. The HSS 1330 can provide support for routing/roaming, authentication, authorization, naming/addressing resolution, location dependencies, etc. An S6a reference point between the HSS 1330 and the MME 1324 may enable transfer of subscription and authentication data for authenticating/authorizing user access to the LTE CN 1320.

The PGW 1332 may terminate an SGi interface toward a data network (DN) 1336 that may include an application/content server 1338. The PGW 1332 may route data packets between the LTE CN 1322 and the data network 1336. The PGW 1332 may be coupled with the SGW 1326 by an S5 reference point to facilitate user plane tunneling and tunnel management. The PGW 1332 may further include a node for policy enforcement and charging data collection (for example, PCEF). Additionally, the SGi reference point between the PGW 1332 and the data network 13 36 may be an operator external public, a private PDN, or an intra-operator packet data network, for example, for provision of IMS services. The PGW 1332 may be coupled with a PCRF 1334 via a Gx reference point.

The PCRF 1334 is the policy and charging control element of the LTE CN 1322. The PCRF 1334 may be communicatively coupled to the app/content server 1338 to determine appropriate QoS and charging parameters for service flows. The PCRF 1332 may provision associated rules into a PCEF (via Gx reference point) with appropriate TFT and QCI.

In some embodiments, the CN 1320 may be a 5GC 1340. The 5GC 1340 may include an AUSF 1342, AMF 1344, SMF 1346, UPF 1348, NSSF 1350, NEF 1352, NRF 1354, PCF 1356, UDM 1358, and AF 1360 coupled with one another over interfaces (or “reference points”) as shown. Functions of the elements of the 5GC 1340 may be briefly introduced as follows.

The AUSF 1342 may store data for authentication of UE 1302 and handle authentication-related functionality. The AUSF 1342 may facilitate a common authentication framework for various access types. In addition to communicating with other elements of the 5GC 1340 over reference points as shown, the AUSF 1342 may exhibit an Nausf service-based interface.

The AMF 1344 may allow other functions of the 5GC 1340 to communicate with the UE 1302 and the RAN 1304 and to subscribe to notifications about mobility events with respect to the UE 1302. The AMF 1344 may be responsible for registration management (for example, for registering UE 1302), connection management, reachability management, mobility management, lawful interception of AMF-related events, and access authentication and authorization. The AMF 1344 may provide transport for SM messages between the UE 1302 and the SMF 1346, and act as a transparent proxy for routing SM messages. AMF 1344 may also provide transport for SMS messages between UE 1302 and an SMSF. AMF 1344 may interact with the AUSF 1342 and the UE 1302 to perform various security anchor and context management functions. Furthermore, AMF 1344 may be a termination point of a RAN CP interface, which may include or be an N2 reference point between the RAN 1304 and the AMF 1344; and the AMF 1344 may be a termination point of NAS (N1) signaling, and perform NAS ciphering and integrity protection. AMF 1344 may also support NAS signaling with the UE 1302 over an N3 IWF interface.

The SMF 1346 may be responsible for SM (for example, session establishment, tunnel management between UPF 1348 and AN 1308); UE IP address allocation and management (including optional authorization); selection and control of UP function; configuring traffic steering at UPF 1348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1344 over N2 to AN 1308; and determining SSC mode of a session. SM may refer to management of a PDU session, and a PDU session or “session” may refer to a PDU connectivity service that provides or enables the exchange of PDUs between the UE 1302 and the data network 1336.

The UPF 1348 may act as an anchor point for intra-RAT and inter-RAT mobility, an external PDU session point of interconnect to data network 1336, and a branching point to support multi-homed PDU session. The UPF 1348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1348 may include an uplink classifier to support routing traffic flows to a data network.

The NSSF 1350 may select a set of network slice instances serving the UE 1302. The NSSF 1350 may also determine allowed NSSAI and the mapping to the subscribed S-NSSAIs, if needed. The NSSF 1350 may also determine the AMF set to be used to serve the UE 1302, or a list of candidate AMFs based on a suitable configuration and possibly by querying the NRF 1354. The selection of a set of network slice instances for the UE 1302 may be triggered by the AMF 1344 with which the UE 1302 is registered by interacting with the NSSF 1350, which may lead to a change of AMF. The NSSF 1350 may interact with the AMF 1344 via an N22 reference point; and may communicate with another NSSF in a visited network via an N31 reference point (not shown). Additionally, the NSSF 1350 may exhibit an Nnssf service-based interface.

The NEF 1352 may securely expose services and capabilities provided by 3GPP network functions for third party, internal exposure/re-exposure, AFs (e.g., AF 1360), edge computing or fog computing systems, etc. In such embodiments, the NEF 1352 may authenticate, authorize, or throttle the AFs. NEF 1352 may also translate information exchanged with the AF 1360 and information exchanged with internal network functions. For example, the NEF 1352 may translate between an AF-Service-Identifier and an internal 5GC information. NEF 1352 may also receive information from other NFs based on exposed capabilities of other NFs. This information may be stored at the NEF 1352 as structured data, or at a data storage NF using standardized interfaces. The stored information can then be re-exposed by the NEF 1352 to other NFs and AFs, or used for other purposes such as analytics. Additionally, the NEF 1352 may exhibit an Nnef service-based interface.

The NRF 1354 may support service discovery functions, receive NF discovery requests from NF instances, and provide the information of the discovered NF instances to the NF instances. NRF 1354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1354 may exhibit the Nnrf service-based interface.

The PCF 1356 may provide policy rules to control plane functions to enforce them, and may also support unified policy framework to govern network behavior. The PCF 1356 may also implement a front end to access subscription information relevant for policy decisions in a UDR of the UDM 1358. In addition to communicating with functions over reference points as shown, the PCF 1356 exhibit an Npcf service-based interface.

The UDM 1358 may handle subscription-related information to support the network entities' handling of communication sessions, and may store subscription data of UE 1302. For example, subscription data may be communicated via an N8 reference point between the UDM 1358 and the AMF 1344. The UDM 1358 may include two parts, an application front end and a UDR. The UDR may store subscription data and policy data for the UDM 1358 and the PCF 1356, and/or structured data for exposure and application data (including PFDs for application detection, application request information for multiple UEs 1302) for the NEF 1352. The Nudr service-based interface may be exhibited by the UDR 221 to allow the UDM 1358, PCF 1356, and NEF 1352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1358 may exhibit the Nudm service-based interface.

The AF 1360 may provide application influence on traffic routing, provide access to NEF, and interact with the policy framework for policy control.

In some embodiments, the 5GC 1340 may enable edge computing by selecting operator/3rd party services to be geographically close to a point that the UE 1302 is attached to the network. This may reduce latency and load on the network. To provide edge-computing implementations, the 5GC 1340 may select a UPF 1348 close to the UE 1302 and execute traffic steering from the UPF 1348 to data network 1336 via the N6 interface. This may be based on the UE subscription data, UE location, and information provided by the AF 1360. In this way, the AF 1360 may influence UPF (re)selection and traffic routing. Based on operator deployment, when AF 1360 is considered to be a trusted entity, the network operator may permit AF 1360 to interact directly with relevant NFs. Additionally, the AF 1360 may exhibit an Naf service-based interface.

The data network 1336 may represent various network operator services, Internet access, or third party services that may be provided by one or more servers including, for example, application/content server 1338.

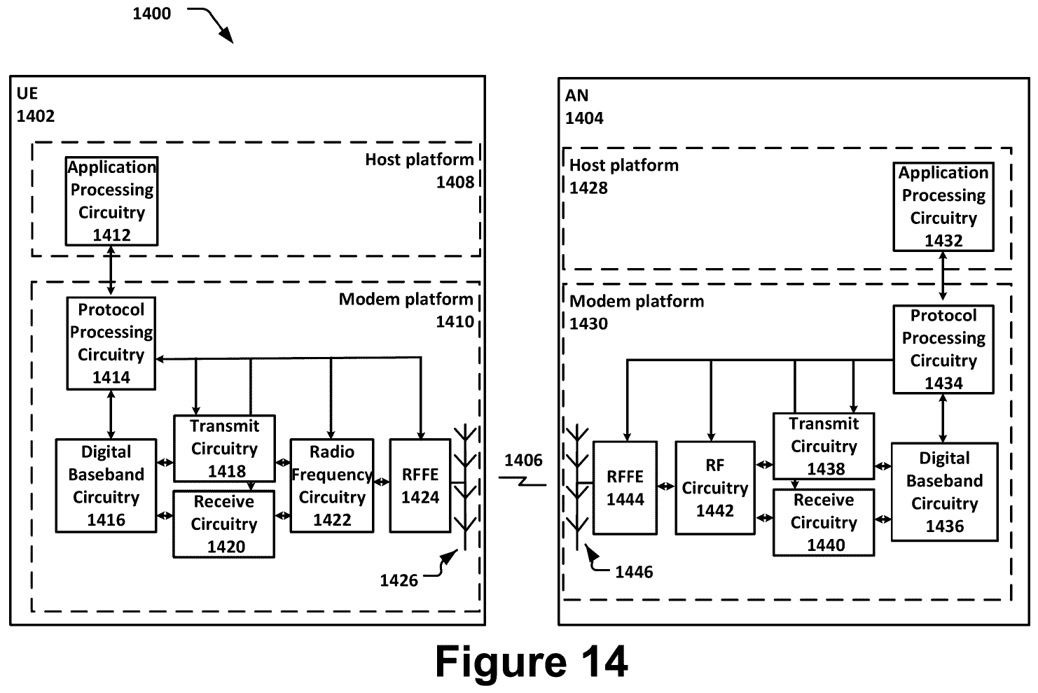

FIG. 14 schematically illustrates a wireless network 1400 in accordance with various embodiments. The wireless network 1400 may include a UE 1402 in wireless communication with an AN 1404. The UE 1402 and AN 1404 may be similar to, and substantially interchangeable with, like-named components described elsewhere herein.

The UE 1402 may be communicatively coupled with the AN 1404 via connection 1406. The connection 1406 is illustrated as an air interface to enable communicative coupling, and can be consistent with cellular communications protocols such as an LTE protocol or a 5G NR protocol operating at mmWave or sub-6 GHz frequencies.

The UE 1402 may include a host platform 1408 coupled with a modem platform 1410. The host platform 1408 may include application processing circuitry 1412, which may be coupled with protocol processing circuitry 1414 of the modem platform 1410. The application processing circuitry 1412 may run various applications for the UE 1402 that source/sink application data. The application processing circuitry 1412 may further implement one or more layer operations to transmit/receive application data to/from a data network. These layer operations may include transport (for example UDP) and Internet (for example, IP) operations

The protocol processing circuitry 1414 may implement one or more of layer operations to facilitate transmission or reception of data over the connection 1406. The layer operations implemented by the protocol processing circuitry 1414 may include, for example, MAC, RLC, PDCP, RRC and NAS operations.

The modem platform 1410 may further include digital baseband circuitry 1416 that may implement one or more layer operations that are “below” layer operations performed by the protocol processing circuitry 1414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1410 may further include transmit circuitry 1418, receive circuitry 1420, RF circuitry 1422, and RF front end (RFFE) 1424, which may include or connect to one or more antenna panels 1426. Briefly, the transmit circuitry 1418 may include a digital-to-analog converter, mixer, intermediate frequency (IF) components, etc.; the receive circuitry 1420 may include an analog-to-digital converter, mixer, IF components, etc.; the RF circuitry 1422 may include a low-noise amplifier, a power amplifier, power tracking components, etc.; RFFE 1424 may include filters (for example, surface/bulk acoustic wave filters), switches, antenna tuners, beamforming components (for example, phase-array antenna components), etc. The selection and arrangement of the components of the transmit circuitry 1418, receive circuitry 1420, RF circuitry 1422, RFFE 1424, and antenna panels 1426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1414 may include one or more instances of control circuitry (not shown) to provide control functions for the transmit/receive components.

A UE reception may be established by and via the antenna panels 1426, RFFE 1424, RF circuitry 1422, receive circuitry 1420, digital baseband circuitry 1416, and protocol processing circuitry 1414. In some embodiments, the antenna panels 1426 may receive a transmission from the AN 1404 by receive-beamforming signals received by a plurality of antennas/antenna elements of the one or more antenna panels 1426.

A UE transmission may be established by and via the protocol processing circuitry 1414, digital baseband circuitry 1416, transmit circuitry 1418, RF circuitry 1422, RFFE 1424, and antenna panels 1426. In some embodiments, the transmit components of the UE 1404 may apply a spatial filter to the data to be transmitted to form a transmit beam emitted by the antenna elements of the antenna panels 1426.

Similar to the UE 1402, the AN 1404 may include a host platform 1428 coupled with a modem platform 1430. The host platform 1428 may include application processing circuitry 1432 coupled with protocol processing circuitry 1434 of the modem platform 1430. The modem platform may further include digital baseband circuitry 1436, transmit circuitry 1438, receive circuitry 1440, RF circuitry 1442, RFFE circuitry 1444, and antenna panels 1446. The components of the AN 1404 may be similar to and substantially interchangeable with like-named components of the UE 1402. In addition to performing data transmission/reception as described above, the components of the AN 1408 may perform various logical functions that include, for example, RNC functions such as radio bearer management, uplink and downlink dynamic radio resource management, and data packet scheduling.

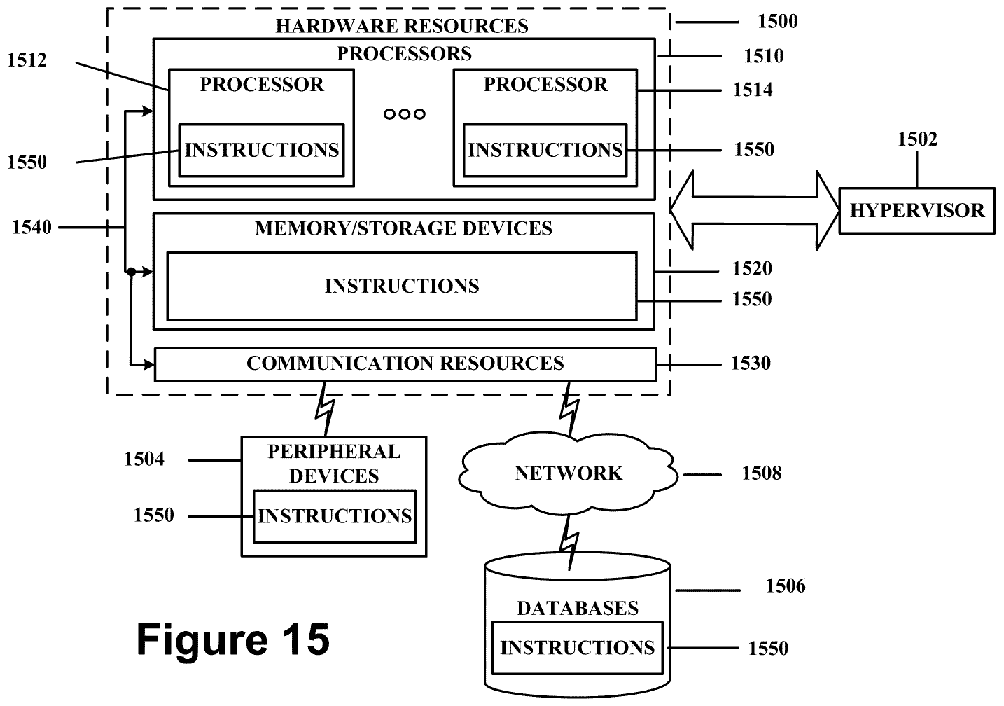

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540 or other interface circuitry. For embodiments where node virtualization (e.g., NFV) is utilized, a hypervisor 1502 may be executed to provide an execution environment for one or more network slices/sub-slices to utilize the hardware resources 1500.

The processors 1510 may include, for example, a processor 1512 and a processor 1514. The processors 1510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1520 may include main memory, disk storage, or any suitable combination thereof. The memory/storage devices 1520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1530 may include interconnection or network interface controllers, components, or other suitable devices to communicate with one or more peripheral devices 1504 or one or more databases 1506 or other network elements via a network 1508. For example, the communication resources 1530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

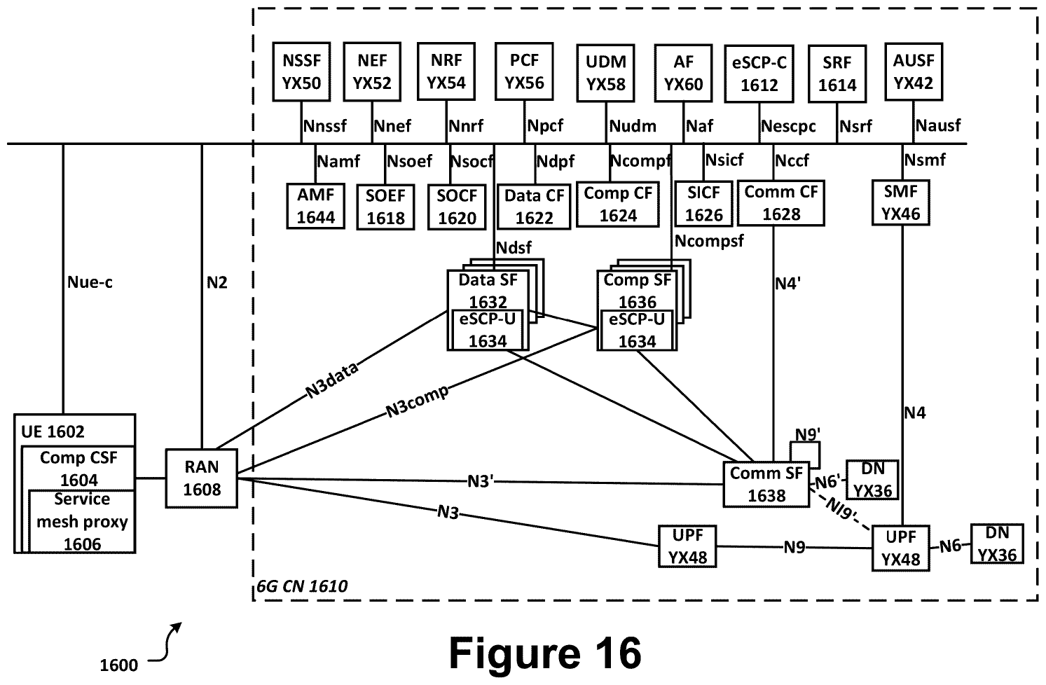

FIG. 16 illustrates a network 1600 in accordance with various embodiments. The network 1600 may operate in a matter consistent with 3GPP technical specifications or technical reports for 6G systems. In some embodiments, the network 1600 may operate concurrently with network 1300. For example, in some embodiments, the network 1600 may share one or more frequency or bandwidth resources with network 1300. As one specific example, a UE (e.g., UE 1602) may be configured to operate in both network 1600 and network 1300. Such configuration may be based on a UE including circuitry configured for communication with frequency and bandwidth resources of both networks 1300 and 1600. In general, several elements of network 1600 may share one or more characteristics with elements of network 1300. For the sake of brevity and clarity, such elements may not be repeated in the description of network 1600.

The network 1600 may include a UE 1602, which may include any mobile or non-mobile computing device designed to communicate with a RAN 1608 via an over-the-air connection. The UE 1602 may be similar to, for example, UE 1302. The UE 1602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 16, in some embodiments the network 1600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 16, the UE 1602 may be communicatively coupled with an AP such as AP 1306 as described with respect to FIG. 13. Additionally, although not specifically shown in FIG. 16, in some embodiments the RAN 1608 may include one or more ANss such as AN 1308 as described with respect to FIG. 13. The RAN 1608 and/or the AN of the RAN 1608 may be referred to as a base station (BS), a RAN node, or using some other term or name.

The UE 1602 and the RAN 1608 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1608 may allow for communication between the UE 1602 and a 6G core network (CN) 1610. Specifically, the RAN 1608 may facilitate the transmission and reception of data between the UE 1602 and the 6G CN 1610. The 6G CN 1610 may include various functions such as NSSF 1350, NEF 1352, NRF 1354, PCF 1356, UDM 1358, AF 1360, SMF 1346, and AUSF 1342. The 6G CN 1610 may additional include UPF 1348 and DN 1336 as shown in FIG. 16.

Additionally, the RAN 1608 may include various additional functions that are in addition to, or alternative to, functions of a legacy cellular network such as a 4G or 5G network. Two such functions may include a Compute Control Function (Comp CF) 1624 and a Compute Service Function (Comp SF) 1636. The Comp CF 1624 and the Comp SF 1636 may be parts or functions of the Computing Service Plane. Comp CF 1624 may be a control plane function that provides functionalities such as management of the Comp SF 1636, computing task context generation and management (e.g., create, read, modify, delete), interaction with the underlying computing infrastructure for computing resource management, etc. Comp SF 1636 may be a user plane function that serves as the gateway to interface computing service users (such as UE 1602) and computing nodes behind a Comp SF instance. Some functionalities of the Comp SF 1636 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1636 instance may serve as the user plane gateway for a cluster of computing nodes. A Comp CF 1624 instance may control one or more Comp SF 1636 instances.

Two other such functions may include a Communication Control Function (Comm CF) 1628 and a Communication Service Function (Comm SF) 1638, which may be parts of the Communication Service Plane. The Comm CF 1628 may be the control plane function for managing the Comm SF 1638, communication sessions creation/configuration/releasing, and managing communication session context. The Comm SF 1638 may be a user plane function for data transport. Comm CF 1628 and Comm SF 1638 may be considered as upgrades of SMF 1346 and UPF 1348, which were described with respect to a 5G system in FIG. 13. The upgrades provided by the Comm CF 1628 and the Comm SF 1638 may enable service-aware transport. For legacy (e.g., 4G or 5G) data transport, SMF 1346 and UPF 1348 may still be used.

Two other such functions may include a Data Control Function (Data CF) 1622 and Data Service Function (Data SF) 1632 may be parts of the Data Service Plane. Data CF 1622 may be a control plane function and provides functionalities such as Data SF 1632 management, Data service creation/configuration/releasing, Data service context management, etc. Data SF 1632 may be a user plane function and serve as the gateway between data service users (such as UE 1602 and the various functions of the 6G CN 1610) and data service endpoints behind the gateway. Specific functionalities may include: parse data service user data and forward to corresponding data service endpoints, generate charging data, report data service status.

Another such function may be the Service Orchestration and Chaining Function (SOCF) 1620, which may discover, orchestrate and chain up communication/computing/data services provided by functions in the network. Upon receiving service requests from users, SOCF 1620 may interact with one or more of Comp CF 1624, Comm CF 1628, and Data CF 1622 to identify Comp SF 1636, Comm SF 1638, and Data SF 1632 instances, configure service resources, and generate the service chain, which could contain multiple Comp SF 1636, Comm SF 1638, and Data SF 1632 instances and their associated computing endpoints. Workload processing and data movement may then be conducted within the generated service chain. The SOCF 1620 may also responsible for maintaining, updating, and releasing a created service chain.

Another such function may be the service registration function (SRF) 1614, which may act as a registry for system services provided in the user plane such as services provided by service endpoints behind Comp SF 1636 and Data SF 1632 gateways and services provided by the UE 1602. The SRF 1614 may be considered a counterpart of NRF 1354, which may act as the registry for network functions.

Other such functions may include an evolved service communication proxy (eSCP) and service infrastructure control function (SICF) 1626, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1612 and eSCP-U 1634, for control plane service communication proxy and user plane service communication proxy, respectively. The SICF 1626 may control and configure eCSP instances in terms of service traffic routing policies, access rules, load balancing configurations, performance monitoring, etc.

Another such function is the AMF 1644. The AMF 1644 may be similar to 1344, but with additional functionality. Specifically, the AMF 1644 may include potential functional repartition, such as move the message forwarding functionality from the AMF 1644 to the RAN 1608.

Another such function is the service orchestration exposure function (SOEF) 1618. The SOEF may be configured to expose service orchestration and chaining services to external users such as applications.

The UE 1602 may include an additional function that is referred to as a computing client service function (comp CSF) 1604. The comp CSF 1604 may have both the control plane functionalities and user plane functionalities, and may interact with corresponding network side functions such as SOCF 1620, Comp CF 1624, Comp SF 1636, Data CF 1622, and/or Data SF 1632 for service discovery, request/response, compute task workload exchange, etc. The Comp CSF 1604 may also work with network side functions to decide on whether a computing task should be run on the UE 1602, the RAN 1608, and/or an element of the 6G CN 1610.

The UE 1602 and/or the Comp CSF 1604 may include a service mesh proxy 1606. The service mesh proxy 1606 may act as a proxy for service-to-service communication in the user plane. Capabilities of the service mesh proxy 1606 may include one or more of addressing, security, load balancing, etc.

### Example Procedures

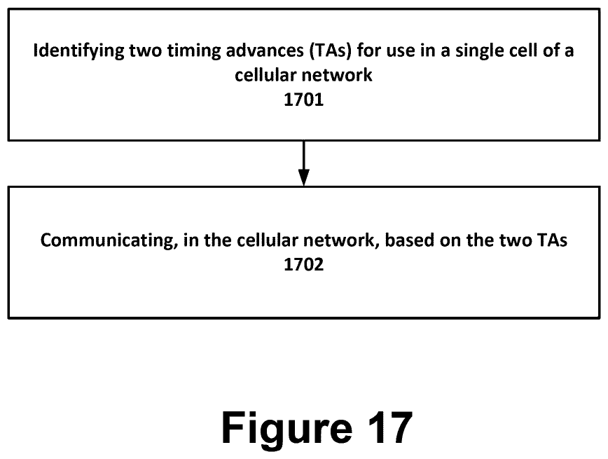

In some embodiments, the electronic device(s), network(s), system(s), chip(s) or component(s), or portions or implementations thereof, of FIGS. 13-16, or some other figure herein, may be configured to perform one or more processes, techniques, or methods as described herein, or portions thereof. One such process is depicted in FIG. 17. The process may relate to a method to be performed by a user equipment (UE) in a new radio (NR) cellular network, one or more elements of the UE, and/or an electronic device that includes the UE. The process may include identifying, at 1701, two timing advances (TAs) for use in a single cell of the cellular network; and communicating, at 1702 in the cellular network, based on the two TAs.

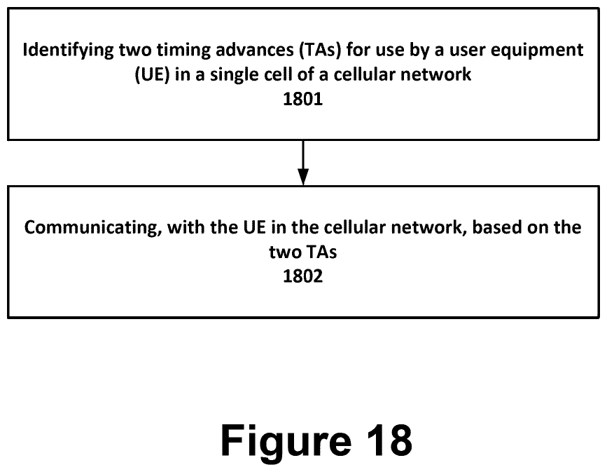

Another such process is depicted in FIG. 18. The process may relate to a method to be performed by a base station in a new radio (NR) cellular network, one or more elements of the base station, and/or an electronic device that includes the base station. The process may include identifying, at 1801, two timing advances (TAs) for use by a user equipment (UE) in a single cell of the cellular network; and communicating, at 1802 with the UE in the cellular network, based on the two TAs.

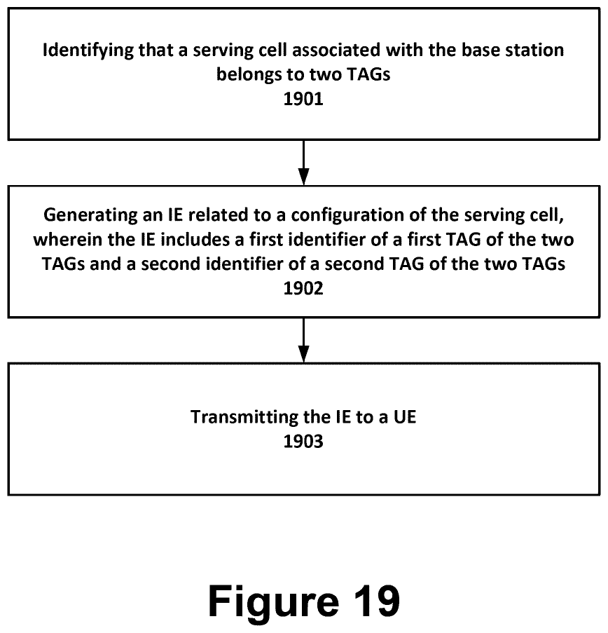

Another such process is depicted in FIG. 19. The process may relate to a method to be performed by a base station, one or more elements of a base station, and/or one or more electronic devices that include and/or implement a base station. The process may include identifying, at 1901, that a serving cell associated with the base station belongs to two timing advance groups (TAGs); generating, at 1902, an information element (IE) related to a configuration of the serving cell, wherein the IE includes a first identifier of a first TAG of the two TAGs and a second identifier of a second TAG of the two TAGs; and transmitting, at 1903, the IE to a user equipment (UE).

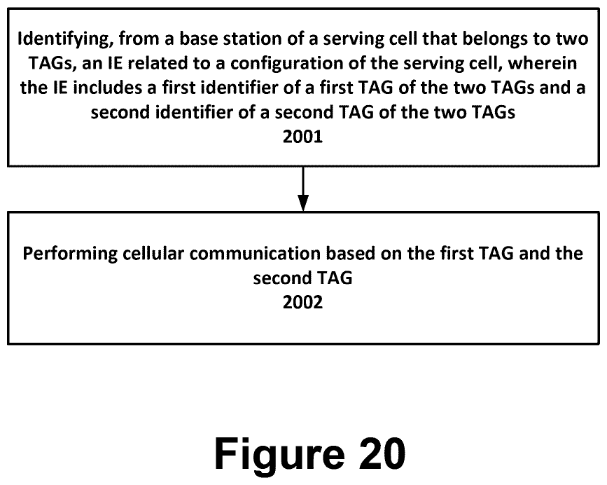

Another such process is depicted in FIG. 20. The process of FIG. 20 may relate to a method to be performed by a user equipment (UE), one or more elements of a UE, and/or one or more electronic devices that include and/or implement a UE. The process may include identifying, at 2001 from a base station of a serving cell that belongs to two timing advance groups (TAGs), an information element (IE) related to a configuration of the serving cell, wherein the IE includes a first identifier of a first TAG of the two TAGs and a second identifier of a second TAG of the two TAGs; and performing, at 2001, cellular communication based on the first TAG and the second TAG.

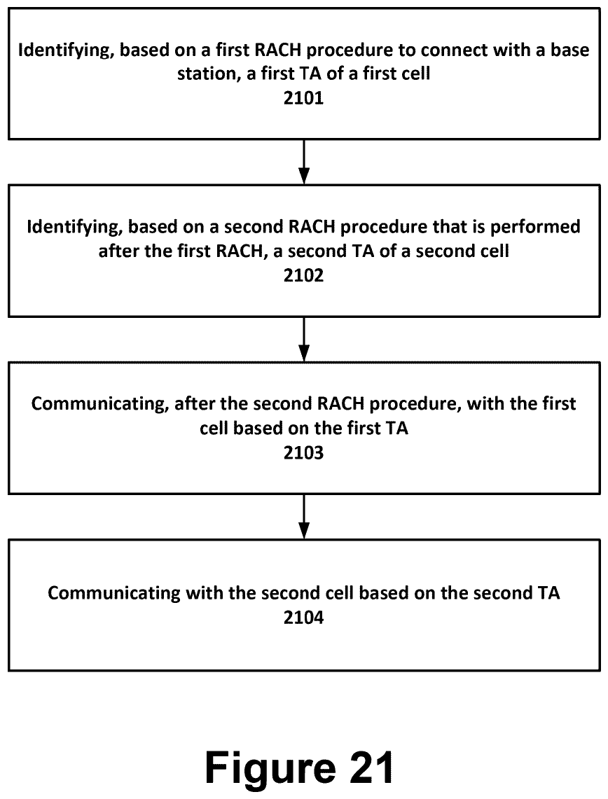

Another such process is depicted in FIG. 21. The process of FIG. 21 may relate to a method to be performed by a user equipment (UE), one or more elements of a UE, and/or one or more electronic devices that includes and/or implement a UE. The process may include identifying, at 2101 based on a first random access channel (RACH) procedure to connect with a base station, a first timing advance (TA) of a first cell; identifying, at 2102 based on a second RACH procedure that is performed after the first RACH, a second TA of a second cell; communicating, at 2103 after the second RACH procedure, with the first cell based on the first TA; and communicating, at 2104 with the second cell based on the second TA.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include an apparatus to be employed as UE in NR system, comprising:
means to support two TAs for a single cell

Example 2 may include UE, once configured by network to enable a second TA, transmits RACH preamble using dedicated RACH resource.

Example 3 may include UE, receives RAR message which includes a TA value used for a second TA.

Example 4 may include UE, receives TA command MAC CE including TA ID.

Example 5 may include UE, once two TAs are enabled for a single cell and one TA timer expires, reports TA failure to network

Example 6 may include UE, calculates the second TA value based on the first TA and downlink timing difference between reference signals

Example 7 may include UE, once configured by network to activate one TA, e.g., by dedicated MAC CE, or RRC configuration, or association with TCI-state, uses the corresponding TA for uplink transmission

Example 8 includes a method to be performed by a user equipment (UE) in a new radio (NR) cellular network, one or more elements of the UE, and/or an electronic device that includes the UE, wherein the method comprises:
identifying two timing advances (TAs) for use in a single cell of the cellular network; and
communicating, in the cellular network, based on the two TAs.

Example 9 includes the method of example 8, and/or some other example herein, wherein the communicating includes transmitting a random access channel (RACH) preamble on a dedicated RACH resource based on one of the two TAs.

Example 10 includes the method of example 9, and/or some other example herein, wherein the communicating includes transmitting another message in accordance with the other of the two TAs.

Example 11 includes the method of any of examples 8-10, and/or some other example herein, wherein the identifying is based on an indication in a message received from a base station of the cellular network.

Example 12 includes the method of example 11, and/or some other example herein, wherein the indication is in a MAC random access response (RAR) MAC.

Example 13 includes the method of example 11, and/or some other example herein, wherein the indication is in a MAC control element (CE).

Example 14 includes the method of any of examples 8-10, and/or some other example herein, wherein identifying the second TA is based on the first TA.

Example 15 includes a method to be performed by a base station in a new radio (NR) cellular network, one or more elements of the base station, and/or an electronic device that includes the base station, wherein the method comprises:
identifying two timing advances (TAs) for use by a user equipment (UE) in a single cell of the cellular network; and
communicating, with the UE in the cellular network, based on the two TAs.

Example 16 includes the method of example 15, and/or some other example herein, wherein the communicating includes identifying a random access channel (RACH) preamble that was transmitting on a dedicated RACH resource based on one of the two TAs.

Example 17 includes the method of example 16, and/or some other example herein, wherein the communicating includes identifying another message in accordance with the other of the two TAs.

Example 18 includes the method of any of examples 15-17, and/or some other example herein, further comprising transmitting an indication of one or more of the two TAs to the UE.

Example 19 includes the method of example 18, and/or some other example herein, wherein the indication is in a MAC random access response (RAR) MAC.

Example 20 includes the method of example 18, and/or some other example herein, wherein the indication is in a MAC control element (CE).

Example 21 includes the method of any of examples 15-17, and/or some other example herein, wherein the UE is to identify the second TA is based on the first TA.

Example 22 includes a method to be performed by a base station, one or more elements of a base station, and/or one or more electronic devices that include and/or implement a base station, wherein the method comprises: identifying that a serving cell associated with the base station belongs to two timing advance groups (TAGs); generating an information element (IE) related to a configuration of the serving cell, wherein the IE includes a first identifier of a first TAG of the two TAGs and a second identifier of a second TAG of the two TAGs; and transmitting the IE to a user equipment (UE).

Example 23 includes the method of example 22, and/or some other example herein, wherein the IE is a ServingCellConfig IE.

Example 24 includes the method of any of examples 22-23, and/or some other example herein, wherein: the first TAG corresponds to a first timing advance (TA) value and a first TA timer; and the second TAG corresponds to a second TA value and a second TA timer.

Example 25 includes the method of any of examples 22-24, and/or some other example herein, wherein the first identifier is a tag-ID field of the IE, and wherein the second identifier is a tag-Id2 field of the IE.

Example 26 includes the method of any of examples 22-25, and/or some other example herein, further comprising transmitting, to the UE, an indication that the first TAG is associated with a first transmission configuration indicator (TCI)-state identifier, and the second TAG is associated with a second TCI-state identifier.

Example 27 includes the method of example 26, and/or some other example herein, wherein the indication is transmitted in downlink control information (DCI), radio resource control (RRC) signaling, or a medium access control (MAC) control element (CE).

Example 28 includes the method of any of examples 22-27, and/or some other example herein, further comprising identifying, from the UE, a first signal based on the first TAG and a second signal based on the second TAG.

Example 29 includes a method to be performed by a user equipment (UE), one or more elements of a UE, and/or one or more electronic devices that include and/or implement a UE, wherein the method comprises: identifying, from a base station of a serving cell that belongs to two timing advance groups (TAGs), an information element (IE) related to a configuration of the serving cell, wherein the IE includes a first identifier of a first TAG of the two TAGs and a second identifier of a second TAG of the two TAGs; and performing cellular communication based on the first TAG and the second TAG.

Example 30 includes the method of example 29, and/or some other example herein, wherein the IE is a ServingCellConfig IE.

Example 31 includes the method of any of examples 29-30, and/or some other example herein, wherein: the first TAG corresponds to a first timing advance (TA) value and a first TA timer; and the second TAG corresponds to a second TA value and a second TA timer.

Example 32 includes the method of any of examples 29-31, and/or some other example herein, wherein the first identifier is a tag-ID field of the IE, and wherein the second identifier is a tag-Id2 field of the IE.

Example 33 includes the method of any of examples 29-32, and/or some other example herein, further comprising identifying, from the base station, an indication that the first TAG is associated with a first transmission configuration indicator (TCI)-state identifier, and the second TAG is associated with a second TCI-state identifier.

Example 34 includes the method of example 33, and/or some other example herein, wherein the indication is identified in downlink control information (DCI), radio resource control (RRC) signaling, or a medium access control (MAC) control element (CE).

Example 35 includes a method to be performed by a user equipment (UE), one or more elements of a UE, and/or one or more electronic devices that includes and/or implement a UE, wherein the method comprises: identifying, based on a first random access channel (RACH) procedure to connect with a base station, a first timing advance (TA) of a first cell; identifying, based on a second RACH procedure that is performed after the first RACH, a second TA of a second cell; communicating, after the second RACH procedure, with the first cell based on the first TA; and communicating with the second cell based on the second TA.

Example 36 includes the method of example 35, and/or some other example herein, wherein the second RACH procedure is based on an order received from the base station.

Example 37 includes the method of example 36, and/or some other example herein, wherein the order is an element of a physical downlink control channel (PDCCH) transmission.

Example 38 includes the method of example 36, and/or some other example herein, wherein the second RACH procedure is a contention-free RACH procedure.

Example 39 includes the method of example 36, and/or some other example herein, wherein the order includes an indication of a dedicated RACH source or an indication of quasi co-location (QCL) information for use during the second RACH procedure.

Example 40 includes the method of any of examples 35-39, and/or some other example herein, wherein the first cell and the second cell are respectively associated with a first transmit/receive point (TRP) and a second TRP.

Example 41 includes the method of any of examples 35-40, and/or some other example herein, wherein the first cell and the second cell are cells of the base station.

Example Z01 may include an apparatus comprising means to perform one or more elements of a method described in or related to any of examples 1-41, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-41, or any other method or process described herein.

Example Z03 may include an apparatus comprising logic, modules, or circuitry to perform one or more elements of a method described in or related to any of examples 1-41, or any other method or process described herein.

Example Z04 may include a method, technique, or process as described in or related to any of examples 1-41, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-41, or portions thereof.

Example Z06 may include a signal as described in or related to any of examples 1-41, or portions or parts thereof.

Example Z07 may include a datagram, packet, frame, segment, protocol data unit (PDU), or message as described in or related to any of examples 1-41, or portions or parts thereof, or otherwise described in the present disclosure.

Example Z08 may include a signal encoded with data as described in or related to any of examples 1-41, or portions or parts thereof, or otherwise described in the present disclosure.

Example Z09 may include a signal encoded with a datagram, packet, frame, segment, protocol data unit (PDU), or message as described in or related to any of examples 1-41, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-41, or portions thereof.

Example Z11 may include a computer program comprising instructions, wherein execution of the program by a processing element is to cause the processing element to carry out the method, techniques, or process as described in or related to any of examples 1-41, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third | Programming Interface | BSR Buffer Status |
| Generation | APN Access Point | Report |
| Partnership Project | Name | BW Bandwidth |
| 4G Fourth Generation | ARP Allocation and | BWP Bandwidth Part |
| 5G Fifth Generation | Retention Priority | C-RNTI Cell Radio |
| 5GC 5G Core network | ARQ Automatic Repeat | Network Temporary |
| AC Application | Request | Identity |
| Client | AS Access Stratum | CA Carrier |
| ACR Application | ASP Application | Aggregation, |
| Context Relocation | Service Provider | Certification |
| ACK | ASN.1 Abstract Syntax | Authority |
| Acknowledgement | Notation One | CAPEX CAPital |
| ACID Application | AUSF Authentication | Expenditure |
| Client Identification | Server Function | CBRA Contention |
| AF Application | AWGN Additive | Based |
| Function | White Gaussian | Random Access |
| AM Acknowledged | Noise | CC Component |
| Mode | BAP Backhaul | Carrier, |
| AMBR Aggregate | Adaptation Protocol | Country Code, |
| Maximum Bit Rate | BCH Broadcast Channel | Cryptographic |
| AMF Access and | BER Bit Error Ratio | Checksum |
| Mobility | BFD Beam Failure | CCA Clear Channel |
| Management | Detection | Assessment |
| Function | BLER Block Error Rate | CCE Control Channel |
| AN Access Network | BPSK Binary | Element |
| ANR Automatic | Phase Shift | CCCH Common |
| Neighbour Relation | Keying | Control Channel |
| AOA Angle of | BRAS Broadband | CE Coverage |
| Arrival | Remote | Enhancement |
| AP Application | Access Server | CDM Content Delivery |
| Protocol, Antenna | BSS Business Support | Network |
| Port, Access Point | System | CDMA Code- |
| API Application | BS Base Station | Division Multiple |
| Access | Point | Indicator, CSI-RS |
| CDR Charging Data | CORESET Control | Resource Indicator |
| Request | Resource Set | C-RNTI Cell RNTI |
| CDR Charging Data | COTS Commercial | CS Circuit Switched |
| Response | Off-The-Shelf | CSCF call session |
| CFRA Contention | CP Control Plane, | control function |
| Free | Cyclic Prefix, | CSAR Cloud Service |
| Random Access | Connection | Archive |
| CG Cell Group | Point | CSI Channel-State |
| CGF Charging | CPD Connection Point | Information |
| Gateway Function | Descriptor | CSI-IM CSI |
| CHF Charging | CPE Customer Premise | Interference |
| Function | Equipment | Measurement |
| CI Cell Identity | CPICHCommon Pilot | CSI-RS CSI |
| CID Cell-ID (e.g., | Channel | Reference Signal |
| positioning method) | CQI Channel Quality | CSI-RSRP CSI |
| CIM Common | Indicator | reference signal |
| Information Model | CPU CSI processing | received power |
| CIR Carrier to | unit, Central | CSI-RSRQ CSI |
| Interference Ratio | Processing | reference signal |
| CK Cipher Key | Unit | received quality |
| CM Connection | C/R | CSI-SINR |
| Management, | Command/Response | CSI signal- |
| Conditional | field bit | to-noise and |
| Mandatory | CRAN Cloud Radio | interference ratio |
| CMAS Commercial | Access Network, | CSMA Carrier Sense |
| Mobile Alert Service | Cloud RAN | Multiple Access |
| CMD Command | CRB Common | CSMA/CA CSMA |
| CMS Cloud | Resource | with |
| Management | Block | collision avoidance |
| System | CRC Cyclic | CSS Common Search |
| CO Conditional | Redundancy | Space, Cell- specific |
| Optional | Check | Search Space |
| COMP Coordinated | CRI Channel-State | Computing Service |
| Multi- | Information Resource | Provider |
| CTF Charging | Reception | EDN Edge Data |
| Trigger Function | DSL Domain Specific | Network |
| CTS Clear-to-Send | Language. Digital | EEC Edge |
| CW Codeword | Subscriber Line | Enabler Client |
| CWS Contention | DSLAM DSL Access | EECID Edge |
| Window Size | Multiplexer | Enabler Client |
| D2D | DwPTS Downlink | Identification |
| Device-to-Device | Pilot Time Slot | EES Edge |
| DC Dual | E-LAN Ethernet | Enabler Server |
| Connectivity, | Local Area Network | EESID Edge |
| Direct Current | E2E End-to-End | Enabler Server |
| DCI Downlink | EAS Edge | Identification |
| Control | Application | EHE Edge |
| Information | Server | Hosting Environment |
| DF Deployment | ECCA extended clear | EGMF Exposure |
| Flavour | channel assessment, | Governance |
| DL Downlink | extended CCA | Management |
| DMTF Distributed | ECCE Enhanced | Function |
| Management Task | Control | EGPRS Enhanced |
| Force | Channel Element, | GPRS |
| DPDK Data Plane | Enhanced CCE | EIR Equipment |
| Development Kit | ED Energy Detection | Identity |
| DM-RS, DMRS | EDGE Enhanced | Register |
| Demodulation | Datarates | eLAA enhanced |
| Reference Signal | for GSM Evolution | Licensed |
| DN Data network | (GSM Evolution) | Assisted Access, |
| DNN Data Network | EAS Edge | enhanced LAA |
| Name | Application Server | EM Element |
| DNAI Data Network | EASID Edge | Manager |
| Access Identifier | Application Server | eMBB Enhanced |
| DRB Data | Identification | Mobile |
| Radio Bearer | ECS Edge | Broadband |
| DRS Discovery | Configuration Server | EMS Element |
| Reference Signal | ECSP Edge | FDM Frequency |
| DRX Discontinuous | UTRAN | Division |
| Management System | EV2X Enhanced V2X | Multiplex |
| eNB evolved NodeB, | F1AP F1 Application | FDMA Frequency |
| E-UTRAN Node B | Protocol | Division |
| EN-DC E-UTRA- | F1-C F1 Control plane | Multiple Access |
| NR Dual | interface | FE Front End |
| Connectivity | F1-U F1 User plane | FEC Forward Error |
| EPC Evolved Packet | interface | Correction |
| Core | FACCH Fast | FFS For Further Study |
| EPDCCH enhanced | Associated Control | FFT Fast Fourier |
| PDCCH, enhanced | CHannel | Transformation |
| Physical Downlink | FACCH/F Fast | feLAA further |
| Control Cannel | Associated Control | enhanced |
| EPRE Energy per | Channel/Full rate | Licensed Assisted |
| resource element | FACCH/H Fast | Access, further |
| EPS Evolved Packet | Associated Control | enhanced LAA |
| System | Channel/Half rate | FN Frame Number |
| EREG enhanced REG, | FACH Forward | FPGA Field- |
| enhanced resource | Access | Programmable Gate |
| element groups | Channel | Array |
| ETSI European | FAUSCH Fast Uplink | FR Frequency Range |
| Telecommunications | Signalling Channel | FQDN Fully |
| Standards Institute | FB Functional Block | Qualified |
| ETWS | FBI Feedback | Domain Name |
| Earthquake and | Information | G-RNTI GERAN |
| Tsunami Warning | FCC Federal | Radio Network |
| System | Communications | Temporary Identity |
| eUICC embedded | Commission | GERAN |
| UICC, | FCCH Frequency | GSM EDGE RAN, |
| embedded Universal | Correction CHannel | GSM EDGE Radio |
| Integrated Circuit | FDD Frequency | Access Network |
| Card | Division | GGSN Gateway GPRS |
| E-UTRA Evolved | Duplex | Support Node |
| UTRA | Protocol for User | GLONASS |
| E-UTRAN Evolved | Plane | HSUPA High Speed |
| GLObal'naya | GTS Go To Sleep | Uplink Packet Access |
| NAvigatsionnaya | Signal | HTTP Hyper Text |
| Sputnikovaya | (related to WUS) | Transfer Protocol |
| Sistema (Engl.: | GUMMEI Globally | HTTPS Hyper Text |
| Global Navigation | Unique MME | Transfer Protocol |
| Satellite System) | Identifier | Secure (https is |
| gNB Next Generation | GUTI Globally Unique | http/1.1 over SSL, |
| NodeB | Temporary | i.e. port 443) |
| gNB-CU gNB- | UE Identity | I-Block Information |
| centralized unit, Next | HARQ Hybrid ARQ, | Block |
| Generation NodeB | Hybrid Automatic | ICCID Integrated |
| centralized unit | Repeat Request | Circuit |
| gNB-DU gNB- | HANDO Handover | Card Identification |
| distributed unit, Next | HFN HyperFrame | IAB Integrated |
| Generation NodeB | Number | Access |
| distributed unit | HHO Hard Handover | and Backhaul |
| GNSS Global | HLR Home Location | ICIC Inter-Cell |
| Navigation | Register | Interference |
| Satellite System | HN Home Network | Coordination |
| GPRS General Packet | HO Handover | ID Identity, identifier |
| Radio Service | HPLMN Home | IDFT Inverse Discrete |
| GPSI Generic | Public Land Mobile | Fourier Transform |
| Public Subscription | Network | IE Information |
| Identifier | HSDPA High Speed | element |
| GSM Global System | Downlink Packet | IBE In-Band |
| for Mobile | Access | Emission |
| Communications, | HSN Hopping | IEEE Institute of |
| Groupe Spécial | Sequence | Electrical and |
| Mobile | Number | Electronics |
| GTP GPRS | HSPA High | Engineers |
| Tunneling | Speed Packet | IEI Information |
| Protocol | Access | Element Identifier |
| GTP-UGPRS | HSS Home Subscriber | IEIDL Information |
| Tunnelling | Server | bytes) |
| Element Identifier | Security | kbps kilo-bits |
| Data Length | IP-CAN IP- | per second |
| IETF Internet | Connectivity Access | Kc Ciphering key |
| Engineering Task | Network | Ki Individual |
| Force | IP-M IP Multicast | subscriber |
| IF Infrastructure | IPv4 Internet Protocol | authentication key |
| IIOT Industrial | Version 4 | KPI Key Performance |
| Internet | IPV6 Internet Protocol | Indicator |
| of Things | Version 6 | KQI Key Quality |
| IM Interference | IR Infrared | Indicator |
| Measurement, | IS In Sync | KSI Key Set Identifier |
| Intermodulation, IP | IRP Integration | ksps kilo-symbols per |
| Multimedia | Reference Point | second |
| IMC IMS Credentials | ISDN Integrated | KVM Kernel Virtual |
| IMEI International | Services | Machine |
| Mobile Equipment | Digital Network | L1 Layer 1 (physical |
| Identity | ISIM IM Services | layer) |
| IMGI International | Identity Module | L1-RSRP Layer 1 |
| mobile group identity | ISO International | reference signal |
| IMPI IP Multimedia | Organisation for | received power |
| Private Identity | Standardisation | L2 Layer 2 (data link |
| IMPU IP Multimedia | ISP Internet Service | layer) |
| PUblic identity | Provider | L3 Layer 3 (network |
| IMS IP Multimedia | IWF Interworking- | layer) |
| Subsystem | Function | LAA Licensed Assisted |
| IMSI International | I-WLAN | Access |
| Mobile Subscriber | Interworking | LAN Local Area |
| Identity | WLAN | Network |
| IOT Internet of Things | Constraint length of | LADN Local Area |
| IP Internet Protocol | the convolutional code, | Data Network |
| Ipsec IP Security, | USIM Individual key | LBT Listen Before Talk |
| Internet Protocol | kB Kilobyte (1000 | coding scheme |
| LCM LifeCycle | MAC Medium | MDAF Management |
| Management | Access | Data |
| LCR Low Chip Rate | Control (protocol | Analytics Function |
| LCS Location | layering context) | MDAS Management |
| Services | MAC Message | Data |
| LCID Logical | authentication code | Analytics Service |
| Channel ID | (security/encryption | MDT Minimization of |
| LI Layer Indicator | context) | Drive Tests |
| LLC Logical Link | MAC-A MAC used | ME Mobile Equipment |
| Control, Low Layer | for authentication and | MeNB master eNB |
| Compatibility | key agreement | MER Message Error |
| LMF Location | (TSG T | Ratio |
| Management | WG3 context) | MGL Measurement |
| Function | MAC-IMAC used for | Gap |
| LOS Line of | data integrity of | Length |
| Sight | signalling messages | MGRP Measurement |
| LPLMN Local | (TSGT WG3 context) | Gap |
| PLMN | MANO | Repetition Period |
| LPP LTE Positioning | Management and | MIB Master |
| Protocol | Orchestration | Information |
| LSB Least Significant | MBMS Multimedia | Block, Management |
| Bit | Broadcast and | Information Base |
| LTE Long Term | Multicast | MIMO Multiple Input |
| Evolution | Service | Multiple Output |
| LWA LTE-WLAN | MBSFN Multimedia | MLC Mobile Location |
| aggregation | Broadcast multicast | Centre |
| LWIP LTE/WLAN | service Single | MM Mobility |
| Radio | Frequency | Management |
| Level Integration with | Network | MME Mobility |
| IPsec Tunnel | MCC Mobile Country | Management Entity |
| LTE Long Term | Code | MN Master Node |
| Evolution | MCG Master | MNO Mobile |
| M2M Machine-to- | Cell Group | Network Operator |
| Machine | MCOT Maximum | MO Measurement |
| Originated | Channel Occupancy | Object, Mobile |
| MPBCH MTC | Time | UTRA Dual |
| Physical Broadcast | MCS Modulation and | Connectivity |
| CHannel | Number | NEF Network |
| MPDCCH MTC | MSISDN Mobile | Exposure |
| Physical Downlink | Subscriber ISDN | Function |
| Control CHannel | Number | NF Network Function |
| MPDSCH MTC | MT Mobile Terminated, | NFP Network |
| Physical Downlink | Mobile Termination | Forwarding Path |
| Shared CHannel | MTC Machine-Type | NFPD Network |
| MPRACH MTC | Communications | Forwarding Path |
| Physical Random | mMTCmassive MTC, | Descriptor |
| Access CHannel | massive Machine- | NFV Network |
| MPUSCH MTC | Type Communications | Functions |
| Physical Uplink | MU-MIMO Multi User | Virtualization |
| Shared | MIMO | NFVI NFV |
| Channel | MWUS MTC wake- | Infrastructure |
| MPLS MultiProtocol | up signal, MTC | NFVO NFV |
| Label Switching | WUS | Orchestrator |
| MS Mobile Station | NACK Negative | NG Next Generation, |
| MSB Most | Acknowledgement | Next Gen |
| Significant | NAI Network Access | NGEN-DC NG-RAN |
| Bit | Identifier | E-UTRA-NR Dual |
| MSC Mobile | NAS Non-Access | Connectivity |
| Switching | Stratum, Non-Access | NM Network Manager |
| Centre | Stratum layer | NMS Network |
| MSI Minimum | NCT Network | Management System |
| System | Connectivity Topology | N-POP Network Point |
| Information, MCH | NC-JT Non- | of Presence |
| Scheduling | Coherent Joint | NMIB, N-MIB |
| Information | Transmission | Narrowband MIB |
| MSID Mobile Station | NEC Network | NPBCH Narrowband |
| Identifier | Capability | Physical Broadcast |
| MSIN Mobile Station | Exposure | CHannel |
| Identification | NE-DC NR-E- | NPDCCH Narrowband |
| Control CHannel | NSSAINetwork Slice | Physical Downlink |
| NPDSCH | Selection Assistance | Power Ratio |
| Narrowband | Information | PAR Peak to Average |
| Physical Downlink | S-NNSAI Single- | Ratio |
| Shared CHannel | NSSAI | PBCH Physical |
| NPRACH | NSSF Network Slice | Broadcast |
| Narrowband | Selection Function | Channel |
| Physical Random | NW Network | PC Power Control, |
| Access CHannel | NWUSNarrowband | Personal Computer |
| NPUSCH Narrowband | wake- | PCC Primary |
| Physical Uplink | up signal, Narrowband | Component Carrier, |
| Shared CHannel | WUS | Primary CC |
| NPSS Narrowband | NZP Non-Zero Power | P-CSCF Proxy |
| Primary | O&M Operation and | CSCF |
| Synchronization | Maintenance | PCell Primary Cell |
| Signal | ODU2 Optical channel | PCI Physical Cell ID, |
| NSSS Narrowband | Data Unit-type 2 | Physical Cell |
| Secondary | OFDM Orthogonal | Identity |
| Synchronization | Frequency Division | PCEF Policy and |
| Signal | Multiplexing | Charging |
| NR New Radio, | OFDMA Orthogonal | Enforcement |
| Neighbour Relation | Frequency Division | Function |
| NRF NF Repository | Multiple Access | PCF Policy Control |
| Function | OOB Out-of-band | Function |
| NRS Narrowband | OOS Out of Sync | PCRF Policy Control |
| Reference Signal | OPEX OPerating | and Charging Rules |
| NS Network Service | EXpense | Function |
| NSA Non-Standalone | OSI Other System | PDCP Packet Data |
| operation mode | Information | Convergence |
| NSD Network Service | OSS Operations | Protocol, |
| Descriptor | Support | Packet Data |
| NSR Network Service | System | Convergence |
| Record | OTA over-the-air | Protocol layer |
| Downlink Control | PAPR Peak-to-Average | PDCCH Physical |
| Channel | Function Descriptor | PSSCH Physical |
| PDCP Packet Data | PNFR Physical Network | Sidelink Shared |
| Convergence Protocol | Function Record | Channel |
| PDN Packet Data | POC PTT over Cellular | PSFCH physical |
| Network, Public Data | PP, PTP Point-to- | sidelink feedback |
| Network | Point | channel |
| PDSCH Physical | PPP Point-to-Point | PSCell Primary SCell |
| Downlink Shared | Protocol | PSS Primary |
| Channel | PRACH Physical | Synchronization |
| PDU Protocol | RACH | Signal |
| Data Unit | PRB Physical resource | PSTN Public |
| PEI Permanent | block | Switched |
| Equipment Identifiers | PRG Physical resource | Telephone Network |
| PFD Packet Flow | block group | PT-RS Phase-tracking |
| Description | ProSe Proximity | reference signal |
| P-GW PDN Gateway | Services, | PTT Push-to-Talk |
| PHICH Physical | Proximity-Based | PUCCH Physical |
| hybrid-ARQ indicator | Service | Uplink Control |
| channel | PRS Positioning | Channel |
| PHY Physical layer | Reference Signal | PUSCH Physical |
| PLMN Public Land | PRR Packet Reception | Uplink Shared |
| Mobile Network | Radio | Channel |
| PIN Personal | PS Packet Services | QAM Quadrature |
| Identification Number | PSBCH Physical | Amplitude Modulation |
| PM Performance | Sidelink Broadcast | QCI QoS class of |
| Measurement | Channel | identifier |
| PMI Precoding Matrix | PSDCH Physical | QCL Quasi co-location |
| Indicator | Sidelink Downlink | QFI QoS Flow ID, QoS |
| PNF Physical Network | Channel | Flow Identifier |
| Function | PSCCH Physical | QoS Quality of Service |
| PNFD Physical | Sidelink Control | QPSK Quadrature |
| Network | Channel | (Quaternary) Phase |
| Keying | REQ REQuest | Shift |
| QZSS Quasi-Zenith | RF Radio Frequency | Temporary Identifier |
| Satellite System | RI Rank Indicator | ROHC RObust Header |
| RA-RNTI Random | RIV Resource indicator | Compression |
| Access RNTI | value | RRC Radio Resource |
| RAB Radio Access | RL Radio Link | Control, Radio |
| Bearer, Random | RLC Radio Link | Resource Control layer |
| Access Burst | Control, Radio Link | RRM Radio Resource |
| RACH Random | Control layer | Management |
| Access Channel | RLC AM RLC | RS Reference Signal |
| RADIUS Remote | Acknowledged Mode | RSRP Reference Signal |
| Authentication Dial In | RLC UM RLC | Received Power |
| User Service | Unacknowledged Mode | RSRQ Reference Signal |
| RAN Radio Access | RLF Radio | Received Quality |
| Network | Link Failure | RSSI Received Signal |
| RAND RANDom | RLM Radio Link | Strength Indicator |
| number (used for | Monitoring | RSU Road Side Unit |
| authentication) | RLM-RS Reference | RSTD Reference |
| RAR Random Access | Signal for RLM | Signal |
| Response | RM Registration | Time difference |
| RAT Radio Access | Management | RTP Real Time |
| Technology | RMC Reference | Protocol |
| RAU Routing Area | Measurement Channel | RTS Ready-To-Send |
| Update | RMSI Remaining MSI, | RTT Round Trip Time |
| RB Resource block, | Remaining Minimum | Rx Reception, |
| Radio Bearer | System Information | Receiving, Receiver |
| RBG Resource block | RN Relay Node | S1AP S1 Application |
| group | RNC Radio Network | Protocol |
| REG Resource | Controller | S1-MME S1 for the |
| Element | RNL Radio Network | control plane |
| Group | Layer | S1-U S1 for the user |
| Rel Release | RNTI Radio Network | plane |
| S-GW Serving | Management | S-CSCF serving |
| Gateway | SCS Subcarrier | CSCF |
| S-RNTI SRNC | Spacing | SFN System Frame |
| Radio Network | SCTP Stream Control | Number |
| Temporary Identity | Transmission | SgNB Secondary gNB |
| S-TMSI SAE | Protocol | SGSN Serving GPRS |
| Temporary Mobile | SDAP Service Data | Support Node |
| Station Identifier | Adaptation Protocol, | S-GW Serving Gateway |
| SA Standalone | Service Data Adaptation | SI System Information |
| operation mode | Protocol layer | SI-RNTI System |
| SAE System | SDL Supplementary | Information RNTI |
| Architecture Evolution | Downlink | SIB System Information |
| SAP Service Access | SDNF Structured Data | Block |
| Point | Storage Network | SIM Subscriber Identity |
| SAPD Service Access | Function | Module |
| Point Descriptor | SDP Session | SIP Session Initiated |
| SAPI Service Access | Description | Protocol |
| Point Identifier | Protocol | SIP System in Package |
| SCC Secondary | SDSF Structured Data | SL Sidelink |
| Component Carrier, | Storage Function | SLA Service Level |
| Secondary CC | SDT Small Data | Agreement |
| SCell Secondary Cell | Transmission | SM Session |
| SCEF Service | SDU Service Data Unit | Management |
| Capability Exposure | SEAF Security Anchor | SMF Session |
| Function | Function | Management Function |
| SC-FDMA Single | SeNB secondary eNB | SMS Short Message |
| Carrier Frequency | SEPP Security Edge | Service |
| Division Multiple | Protection Proxy | SMSF SMS Function |
| Access | SFI Slot format | SMTC SSB-based |
| SCG Secondary Cell | indication | Measurement Timing |
| Group | SFTD Space-Frequency | Configuration |
| SCM Security Context | Time Diversity, | SN Secondary Node, |
| SoC System on Chip | SFN and | Sequence Number |
| SON Self-Organizing | frame timing difference | Area Identity |
| Network | Signal Received | TAU Tracking Area |
| SpCell Special Cell | Power | Update |
| SP-CSI-RNTISemi- | SS-RSRQ | TB Transport Block |
| Persistent CSI RNTI | Synchronization | TBS Transport Block |
| SPS Semi-Persistent | Signal based Reference | Size |
| Scheduling | Signal Received | TBD To Be Defined |
| SQN Sequence number | Quality | TCI Transmission |
| SR Scheduling Request | SS-SINR | Configuration Indicator |
| SRB Signalling Radio | Synchronization | TCP Transmission |
| Bearer | Signal based Signal to | Communication |
| SRS Sounding | Noise and Interference | Protocol |
| Reference Signal | Ratio | TDD Time Division |
| SS Synchronization | SSS Secondary | Duplex |
| Signal | Synchronization | TDM Time Division |
| SSB Synchronization | Signal | Multiplexing |
| Signal Block | SSSG Search Space Set | TDMA Time Division |
| SSID Service Set | Group | Multiple Access |
| Identifier | SSSIF Search Space Set | TE Terminal |
| SS/PBCH Block | Indicator | Equipment |
| SSBRI SS/PBCH | SST Slice/Service | TEID Tunnel End Point |
| Block | Types | Identifier |
| Resource Indicator, | SU-MIMO Single User | TFT Traffic Flow |
| Synchronization | MIMO | Template |
| Signal Block | SUL Supplementary | TMSI Temporary |
| Resource Indicator | Uplink | Mobile |
| SSC Session and | TA Timing Advance, | Subscriber Identity |
| Service | Tracking Area | TNL Transport |
| Continuity | TAC Tracking Area | Network |
| SS-RSRP | Code | Layer |
| Synchronization | TAG Timing Advance | TPC Transmit Power |
| Signal based Reference | Group | Control |
| Precoding Matrix | TAI Tracking | TPMI Transmitted |
| Indicator | UDSF Unstructured | UTRAN Universal |
| TR Technical Report | Data Storage Network | Terrestrial Radio |
| TRP, TRxP | Function | Access Network |
| Transmission | UICC Universal | UwPTS Uplink Pilot |
| Reception Point | Integrated Circuit Card | Time Slot |
| TRS Tracking | UL Uplink | V2I Vehicle-to- |
| Reference | UM Unacknowledged | Infrastruction |
| Signal | Mode | V2P Vehicle-to- |
| TRx Transceiver | UML Unified | Pedestrian |
| TS Technical | Modelling | V2V |
| Specifications, | Language | Vehicle-to-Vehicle |
| Technical Standard | UMTS Universal | V2X Vehicle-to- |
| TTI Transmission | Mobile | everything |
| Time Interval | Telecommunications | VIM Virtualized |
| Tx Transmission, | System | Infrastructure Manager |
| Transmitting, | UP User Plane | VL Virtual Link, |
| Transmitter | UPF User Plane | VLAN Virtual LAN, |
| U-RNTI UTRAN | Function | Virtual Local Area |
| Radio Network | URI Uniform Resource | Network |
| Temporary Identity | Identifier | VM Virtual Machine |
| UART Universal | URL Uniform Resource | VNF Virtualized |
| Asynchronous | Locator | Network Function |
| Receiver and | URLLC Ultra- | VNFFG VNF |
| Transmitter | Reliable and Low | Forwarding Graph |
| UCI Uplink Control | Latency | VNFFGD VNF |
| Information | USB Universal Serial | Forwarding Graph |
| UE User Equipment | Bus | Descriptor |
| UDM Unified Data | USIM Universal | VNFM VNF Manager |
| Management | Subscriber Identity | VolP Voice-over-IP, |
| UDP User Datagram | Module | Voice-over-Internet |
| Protocol | USS UE-specific search | Protocol |
| Public Land Mobile | space | VPLMNVisited |
| Network | UTRA UMTS | |
| VPN Virtual Private | Terrestrial | |
| Network | Radio Access | |
| VRB Virtual Resource | | |
| Block | | |
| WiMAX Worldwide | | |
| Interoperability for | | |
| Microwave Access | | |
| WLANWireless Local | | |
| Area Network | | |
| WMAN Wireless | | |
| Metropolitan Area | | |
| Network | | |
| WPANWireless | | |
| Personal | | |
| Area Network | | |
| X2-C X2-Control | | |
| plane | | |
| X2-U X2-User plane | | |
| XML extensible | | |
| Markup | | |
| Language | | |
| XRES Expected user | | |
| RESponse | | |
| XOR exclusive OR | | |
| ZC Zadoff-Chu | | |
| ZP Zero Power | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. A base station comprising:
one or more processors; and
one or more non-transitory computer-readable media comprising instructions that, upon execution of the instructions, are to cause the base station to:
identify that a serving cell associated with the base station belongs to two timing advance groups (TAGs);
generate an information element (IE) related to a configuration of the serving cell, wherein the IE includes a first identifier of a first TAG of the two TAGs and a second identifier of a second TAG of the two TAGs; and
transmit the IE to a user equipment (UE).

2. The base station of claim 1, wherein the IE is a ServingCellConfig IE.

3. The base station of claim 1, wherein:
the first TAG corresponds to a first timing advance (TA) value and a first TA timer; and
the second TAG corresponds to a second TA value and a second TA timer.

4. The base station of claim 1, wherein the first identifier is a tag-ID field of the IE, and wherein the second identifier is a tag-Id2 field of the IE.

5. The base station of claim 1, wherein the instructions are further to cause the base station to transmit, to the UE, an indication that the first TAG is associated with a first transmission configuration indicator (TCI)-state identifier, and the second TAG is associated with a second TCI-state identifier.

6. The base station of claim 5, wherein the indication is transmitted in downlink control information (DCI), radio resource control (RRC) signaling, or a medium access control (MAC) control element (CE).

7. The base station of claim 1, wherein the instructions are further to cause the base station to identify, from the UE, a first signal based on the first TAG and a second signal based on the second TAG.

8. A user equipment (UE) comprising:
one or more processors; and
one or more non-transitory computer-readable media comprising instructions that, upon execution of the instructions by the one or more processors, are to cause the UE to:
identify, from a base station of a serving cell that belongs to two timing advance groups (TAGs), an information element (IE) related to a configuration of the serving cell, wherein the IE includes a first identifier of a first TAG of the two TAGs and a second identifier of a second TAG of the two TAGs; and
perform cellular communication based on the first TAG and the second TAG.

9. The UE of claim 8, wherein the IE is a ServingCellConfig IE.

10. The UE of claim 8, wherein:
the first TAG corresponds to a first timing advance (TA) value and a first TA timer; and
the second TAG corresponds to a second TA value and a second TA timer.

11. The UE of claim 8, wherein the first identifier is a tag-ID field of the IE, and wherein the second identifier is a tag-Id2 field of the IE.

12. The UE of claim 8, wherein the instructions are further to cause the UE to identify, from the base station, an indication that the first TAG is associated with a first transmission configuration indicator (TCI)-state identifier, and the second TAG is associated with a second TCI-state identifier.

13. The UE of claim 12, wherein the indication is identified in downlink control information (DCI), radio resource control (RRC) signaling, or a medium access control (MAC) control element (CE).

14. One or more non-transitory computer-readable media comprising instructions that, upon execution of the instructions by one or more processors of a user equipment (UE), are to cause the UE to:
identify, based on a first random access channel (RACH) procedure to connect with a base station, a first timing advance (TA) of a first cell;
identify, based on a second RACH procedure that is performed after the first RACH, a second TA of a second cell;
communicate, after the second RACH procedure, with the first cell based on the first TA; and
communicate with the second cell based on the second TA.

15. The one or more non-transitory computer-readable media of claim 14, wherein the second RACH procedure is based on an order received from the base station.

16. The one or more non-transitory computer-readable media of claim 15, wherein the order is an element of a physical downlink control channel (PDCCH) transmission.

17. The one or more non-transitory computer-readable media of claim 15, wherein the second RACH procedure is a contention-free RACH procedure.

18. The one or more non-transitory computer-readable media of claim 15, wherein the order includes an indication of a dedicated RACH source or an indication of quasi co-location (QCL) information for use during the second RACH procedure.

19. The one or more non-transitory computer-readable media of claim 14, wherein the first cell and the second cell are respectively associated with a first transmit/receive point (TRP) and a second TRP.

20. The one or more non-transitory computer-readable media of claim 14, wherein the first cell and the second cell are cells of the base station.
